(19) United States
(12) Patent Application Publication
(10) Pub. No.: US 2016/0253128 A1
(43) Pub. Date: Sep. 1, 2016

(54) OUTPUT SYSTEM, TERMINAL DEVICE AND OUTPUT METHOD

(71) Applicant: Shinya MORI, Ohta-ku, Tokyo (JP)

(72) Inventor: Shinya MORI, Tokyo (JP)

(73) Assignee: Ricoh Company, Ltd., Tokyo (JP)

(21) Appl. No.: 15/032,352

(22) PCT Filed: Oct. 28, 2014
(86) PCT No.: PCT/JP2014/079152

§ 371 Date: Apr. 27, 2016

(30) Foreign Application Priority Data
Oct. 31, 2013 (JP) 2013-226358

(51) Int. Cl. G06F 3/12

(52) U.S. Cl. CPC G06F 3/1204; G06F 3/1254; G06F 3/1256; G06F 3/1298

(57) ABSTRACT

An output system, in which a terminal device, an output device and an output control system are connected via a network, includes a setting management unit that receives a setting for a first function of accumulating output data at the terminal device and a setting for a second function of accumulating the output data at the output control system; a selection reception unit that receives a selection of a function to accumulate the output data, the selection indicating either the first or second function; an accumulation control unit that accumulates the output data at the terminal device or at the output control system; an output data related information retention unit that retains output data related information related to the accumulated output data; and an output unit that acquires the accumulated output data based on the output data related information and outputs the output data at the output device.

### TECHNICAL FIELD

The present invention relates to an output system, a terminal device and an output method.

### BACKGROUND ART

Conventionally, so-called pull-print systems have been known in which object data to be printed are specified from a print apparatus side, the object data to be printed based on the specification or a print job based on the object data to be printed are imported via a communication line into the print apparatus side and a printout process is performed (see, for example, Patent Document 1).

### CITATION LIST

### Patent Literature

Patent Document 1: Japanese Published Patent Application No. 2007-200284.

### DISCLOSURE OF INVENTION

### Problem to be Solved by the Invention

However, in the pull-print system, a user may accumulate a print job requiring printing in an accumulation destination by selecting a printer driver from application programs. The accumulation destination of the print job is determined by, for example, an accumulation setting for the printer driver. Accordingly, there is a problem that in the case of changing the accumulation setting for every printing in the pull-print system, the user is required to change the accumulation setting for the printer driver taking account of content of printing or the like, which takes a lot of time.

Meanwhile, the above problem exists not only in a print system such as the pull-print system, but also in an output system in which a user outputs jobs accumulated in the accumulation destination from an output device such as a projector or a monitor.

In view of the above subject matter, it is a general object of at least one embodiment of the present invention to provide an output system, a terminal device and an output method that substantially obviate one or more problems caused by the limitations and disadvantages of the related art.

### Means to Solve the Problem

According to an aspect of the invention, an output system, in which a terminal device, an output device and an output control system including one or more information processing devices are connected via a network, includes a setting management unit that receives a setting for a first function of accumulating output data at the terminal device and a setting for a second function of accumulating the output data at the output control system; a selection reception unit that receives, at the terminal device, a selection of a function to accumulate the output data, which are required to be output, the selection indicating either the first function or the second function at the terminal device; an accumulation control unit that accumulates the output data at the terminal device when the first function is selected and accumulates the output data at the output control system when the second function is selected; an output data related information retention unit that retains output data related information related to the output data accumulated by the selected function at the output control system or at the terminal device, at the output control system; and an output unit that receives the output data related information from output control system, acquires the output data accumulated at the terminal device or at the output control system based on the output data related information and outputs the output data at the output device.

According to another aspect of the invention, a terminal device includes a setting management unit that receives a setting for a first function of accumulating output data at the terminal device and a setting for a second function of accumulating the output data at an information processing device connected via a network; a selection reception unit that receives a selection of a function to accumulate the output data, which are required to be output, the selection indicating either the first function or the second function; an accumulation control unit that accumulates the output data at the terminal device when the first function is selected and accumulates the output data at the information processing device when the second function is selected; an output data related information transmission unit that transmits output data related information related to the output data accumulated by the selected function at the terminal device or at the information processing device to the information processing device; and an output data transmission unit that transmits the output data accumulated at the terminal device to an output device when an acquisition request for the output data accumulated at the terminal device is sent to the terminal device based on the output data related information received by the output device from the information processing device.

According to yet another aspect of the invention, an output method is executed in an output system, in which a terminal device, an output device and an output control system including one or more information processing devices are connected via a network, wherein the terminal device includes a first accumulation unit that accumulates output data and the output control system includes a second accumulation unit that accumulates the output data and an output data related information retention unit that retains output data related information related to the accumulated output data accumulated at the first accumulation unit or at the second accumulation unit. The method includes a setting management step of receiving a setting for a first function of accumulating the output data at the first accumulation unit and a setting for a second function of accumulating the output data at the second accumulation unit; a selection reception step of receiving, at the terminal device, a selection of a function to accumulate the output data, which are required to be output, the selection indicating either the first function or the second function; an accumulation control step of accumulating the output data at the first accumulation unit when the first function is selected and accumulating the output data at the second accumulation unit when the second function is selected; and an output step of acquiring the output data accumulated at the first accumulation unit or at the second accumulation unit based on the output data related information and outputting the output data at the output device.

According to the present invention, an output system, a terminal device and an output method that can easily change the accumulation setting for each output are provided.

### BRIEF DESCRIPTION OF DRAWINGS

FIG. 1 is a diagram illustrating an example of a configuration of a print system according to a present embodiment;

FIG. 2 is a diagram illustrating an example of a hardware configuration of a computer according to the present embodiment;

FIG. 3 is a processing block diagram illustrating an example of a client terminal before installing a software package according to the present embodiment;

FIG. 4 is a diagram illustrating an example of a configuration of the software package according to the present embodiment;

FIG. 5 is a processing block diagram illustrating an example of the client terminal after installing the software package according to the present embodiment;

FIG. 6 is a processing block diagram illustrating an example of a rule-based print control plug-in according to the present embodiment;

FIG. 7 is a processing block diagram illustrating an example of a job accumulation plug-in according to the present embodiment;

FIG. 8 is a processing block diagram illustrating an example of a proxy print by proxy plug-in according to the present embodiment;

FIG. 9 is a processing block diagram illustrating an example of an account plug-in according to the present embodiment;

FIG. 10 is a processing block diagram illustrating an example of a print server device according to the present embodiment;

FIG. 11 is a diagram illustrating an example of a configuration of print job information according to the present embodiment;

FIG. 12 is a diagram illustrating an example of a configuration of proxy user information according to the present embodiment;

FIG. 13 is an image drawing illustrating an example of a screen for a basic setting according to the present embodiment;

FIG. 14 is an image drawing illustrating another example of the screen for the basic setting according to the present embodiment;

FIG. 15 is an image drawing illustrating an example of a screen for a setting for a server according to the present embodiment;

FIG. 16 is an image drawing illustrating an example of a screen for a setting for a job of accumulation according to the present embodiment;

FIG. 17 is an image drawing illustrating an example of a screen for a setting for a proxy print job according to the present embodiment;

FIG. 18 is an image drawing illustrating an example of a screen for a setting for an account according to the present embodiment;

FIG. 19 is an image drawing illustrating an example of a screen for a setting for a print job according to the present embodiment;

FIG. 20 is a flowchart illustrating an example of a process for accumulating print jobs according to the present embodiment;

FIG. 21 is an image drawing illustrating an example of a screen for selecting functions according to the present embodiment;

FIG. 22 is a diagram illustrating an example of a configuration of account information according to the present embodiment;

FIG. 23 is a sequence diagram illustrating an example of a process for outputting a print job according to the present embodiment;

FIG. 24 is a sequence diagram illustrating another example of the process for outputting a print job according to the present embodiment; and

FIG. 25 is an image drawing illustrating an example of a list screen of print job information according to the present embodiment.

### BEST MODE FOR CARRYING OUT THE INVENTION

Next, an embodiment of the present invention will be described in detail. Meanwhile, in the present embodiment, a print system will be exemplified as an example of an output system, but the present invention is not limited to the print system. It may be any system as long as it outputs a job accumulated in an accumulation destination, such as a projection system or a display system.

### First Embodiment

### System Configuration

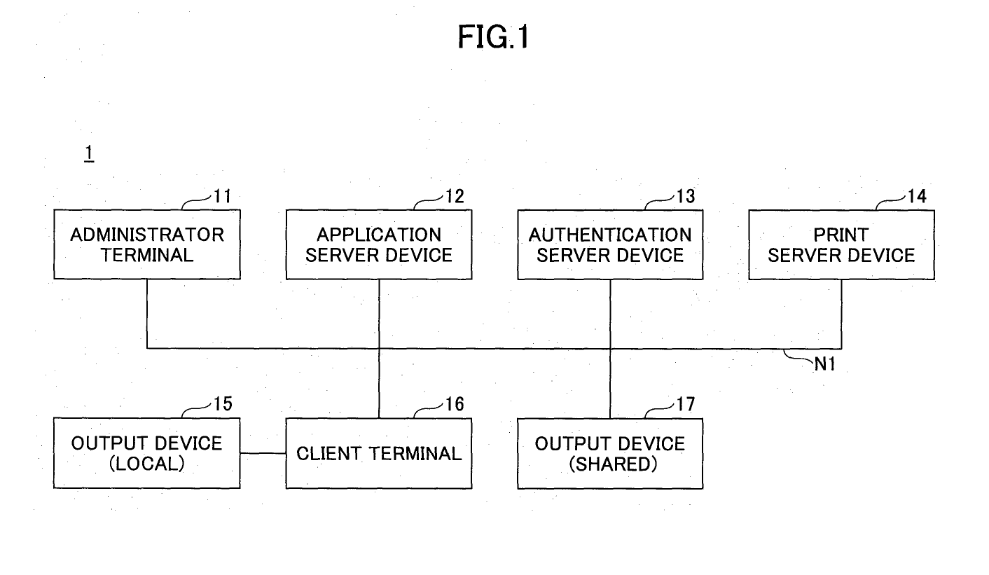

FIG. 1 is a diagram illustrating an example of a configuration of a print system according to the present embodiment. The print system 1 shown in FIG. 1 includes an administrator terminal 11, an application server device 12, an authentication server device 13, a print server device 14, a client terminal 16, and a shared output device 17, which are connected via a network N1 such as a LAN. Moreover, the print system 1 further includes a local output device 15 which is connected to the client terminal 16.

Each of the administrator terminal 11, the application server device 12, the authentication server device 13, the print server device 14, the local output device 15, the client terminal 16 and the shared output device 17 has a wireless or wired communication unit.

FIG. 1 illustrates an example in which there is one of each of the administrator terminal 11, the application server device 12, the authentication server device 13, the print server device 14, the local output device 15, the client terminal 16 and the shared output device 17. However, some of them may be more than one.

The administrator terminal 11 is an information processing apparatus (computer) such as PC (Personal Computer), used by an administrator. The administrator terminal 11, based on a request from the administrator, performs setting operations for client terminals 16 of respective users, and can send the content set as above (setting data) to the device connected via the network N1 such as the application server device 12 or the client terminal 16.

The application server device 12 is realized by one or more information processing devices. The application server device 12 stores application software, such as print application software distributed to the client terminal 16, print setting data, which are setting data for the application software, or the like. The application server device 12 distributes the print application software or the print setting data possessed by the application server device 12 to the client terminal 16.

The authentication server device 13 is realized by one or more information processing devices. The authentication server device 13 possesses user information, and performs an authentication based on a request from the output device 17 or the like. The print server device 14 is realized by one or more information processing devices. The print server device 14 possesses print data or print job information. The print server device 14, based on a request from the output device 17 or the like, sends the print data or the print job information to the output device 17 or the like.

The print server device 14 is an example of a data retention device that possesses output, data related information which is information related to output data of print data or the like or to output data of print job information or the like, and send it to the output device 17 or the like.

For example, when the output device 17 is a projector, the print server device 14 possesses display data (output data) which is desired to be output by displaying (projected) by the projector. Moreover, the print server device 14 can also possess a setting (output data related information) for the display method or the like on outputting by displaying. Moreover, the print server device 14 can possess both the print data and the display data. The print server device 14 sends output data to plural output devices 17 that output different output data, such as a multifunction peripheral that outputs print data by printing, a projector that output display data by displaying or the like according to the output device 17, or sends output data related information. Accordingly, the scope of application of the present invention is not limited to the print data or the print job information.

The output device 15 is an image formation device or the like such as a printer directly connected to the client terminal 16 via wired communication or wireless communication. The output device 15 may be, as well as an image formation device such as a printer, a copier, a multifunction peripheral or a laser printer; a projector or a display device that executes a display output such as a video projector or a monitor; a sound output device that outputs sound data such as audio; or the like.

The client terminal 16 is an information processing device used by a user, such as a PC. The client terminal 16 is a terminal device such as a smartphone, a mobile phone or a PC. The output device 17 is an image forming apparatus or the like connected to the network N1 by wired or wireless communication. The output device 17 may be, as well as an image formation device such as a printer, a copier, a multifunction peripheral or a laser printer; a projector or a display device that executes a display output such as a projector or a monitor; a sound output device that outputs sound data such as audio; or the like.

Meanwhile, the print system 1 shown in FIG. 1 is an example, and the configuration of the print system may be a configuration without the application server device 12, or may be a configuration that realizes, by one device, a function of the authentication server 13 and a function of the print server device 14.

<Hardware Configuration>

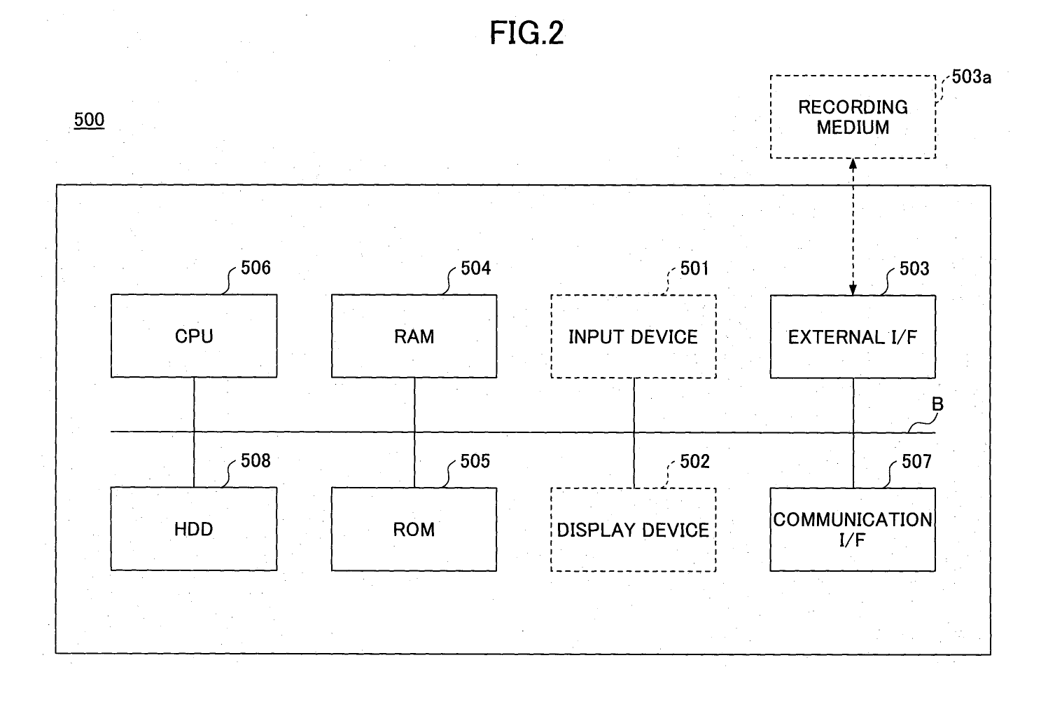

The administrator terminal 11, the application server device 12, the authentication server device 13, the print server device 14 and the client terminal 16 shown in FIG. 1 can be realized by a computer 500 having a hardware configuration shown in FIG. 2. FIG. 2 is a diagram illustrating an example of the hardware configuration of the computer 500 according to the present embodiment.

The computer 500 as shown in FIG. 2 is equipped with an input device 501, a display device 502, an external I/F 503, a RAM 504, a ROM 505, CPU 506, a communication I/F 507, a HDD 508, and the like, which are connected to each other via a bus B. Meanwhile, it may be a configuration in which the input device 501 and the display device 502 are connected and used when they are necessary.

The input device 501 includes a keyboard or a mouse, and is used for the user inputting the respective operational signals. The display device 502 includes a display unit or the like, and displays a result of processing by the computer 500.

The communication I/F 507 is an interface that connect the computer 500 to a network N1. Accordingly, the computer 500 can perform data communication via the communication I/F 507.

The HDD 508 is a non-volatile storage medium that stores programs or data. The stored programs or data include an OS (operating system) which is basic software for controlling overall the computer 500, application software for providing various functions on the OS, or the like.

The external I/F 503 is an interface to an external device. The external device includes a recording medium 503a. Accordingly, the computer 500 can read/write data from/into the recording medium 503a via the external I/F 503. The recording medium 503a includes a flexible disk, a CD (compact disk), a DVD (digital versatile disk), a SD (secure digital) card, a USB (universal serial bus) memory or the like.

The ROM 505 is a non-volatile semiconductor memory (storage device) that can retain programs or data even if power is turned off. In the ROM 505, a program or data of the BIOS (Basic Input/Output System) executed when the computer 500 is activated, a setting for the OS and a setting for the network N1 is stored. The RAM 504 is a volatile semiconductor memory (storage device) that temporarily retains programs or data.

The CPU 506 is an arithmetic device that reads out a program or data from a storage device such as the ROM 505 or the HDD 508 onto the RAM 504, and executes processes, thereby the overall control of the computer 500 and the functions are realized.

The administrator terminal 11, the application server device 12, the authentication server device 13, the print server device 14 and the client terminal 16 according to the present embodiment realize various processing, as described below, according to the hardware configuration of the computer 500 as above.

<Software Configuration>

<<Client Terminal>>

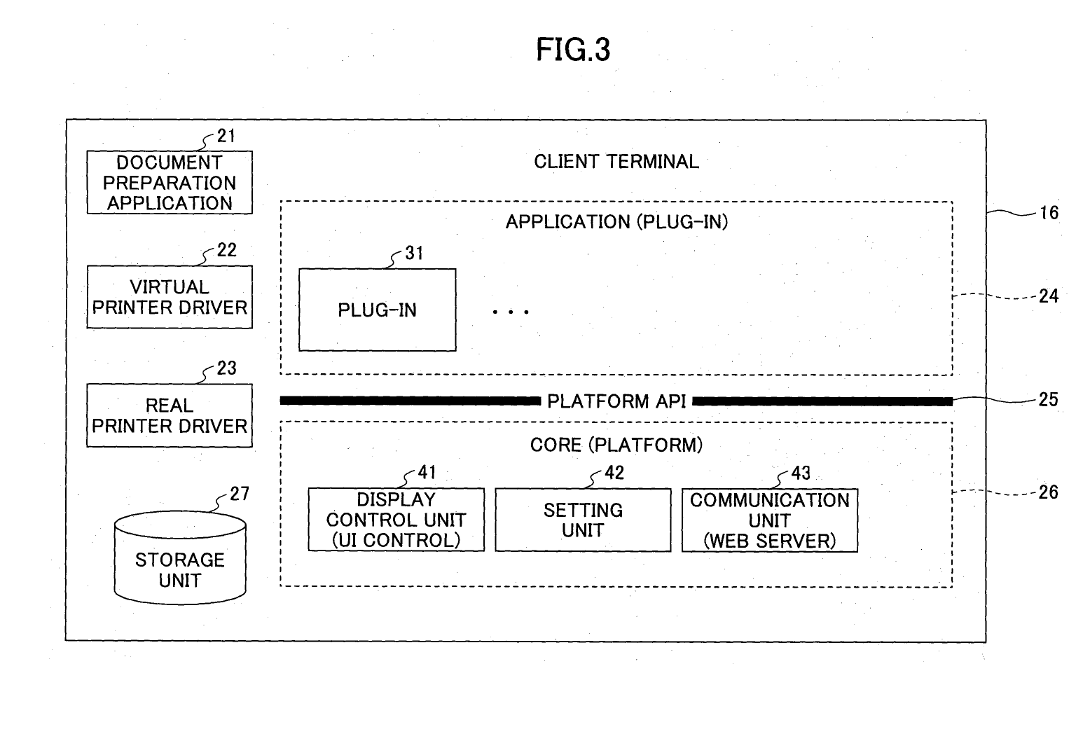

A client terminal 16 before a software package according to the present embodiment is installed is realized by, for example, a processing block diagram, as shown in FIG. 3. FIG. 3 is a processing block diagram illustrating an example of the client terminal 16 before installing the software package according to the present embodiment.

The client terminal 16 as shown in FIG. 3, by executing a program, realizes a document preparation application 21, a virtual printer driver 22, a real printer driver 23, a plug-in application 24, a platform API (application programming interface) 25, a platform 26 and a storage unit 27.

On the plug-in application 24, one or more plug-ins 31 can be installed. The platform 26 includes a display control (UI (user interface) control) unit 41, a setting unit 42 and a communication unit 43. The document preparation application 21 is an example of an application that receives a request for printing from a user. The document preparation application 21 is an example, and may be an application that receives a request for outputting, such as printing, from a user.

The virtual printer driver 22 converts application data into intermediate print data which are machine independent, and outputs the data. Meanwhile, the intermediate print data are print data which are independent of a model of the output device 17 or the like. Data in XPS (XML Paper Specification) format is an example of the intermediate print data. Moreover, the application data are an example of data to be output. Meanwhile, the virtual printer driver 22 may include, for example, a virtual printer driver for the plug-in 31 in order to use the plug-in 31.

The real printer driver 23 converts the intermediate print data into real print data in a format so as to be printed by the output device 15 or the output device 17, and outputs the data. Data in RAW format is an example of the real print data.

The plug-in application 24 is software that operates on the platform 26. The plug-in application 24 can use the functions of the platform 26 by using the platform API 25.

The platform API 25 is an interface so that the plug-in application 24 uses the functions of the platform 26. The platform API 25 is a preliminarily defined interface provided so that the platform 26 receives a request from the plug-in application 24, and includes, for example, a function, a class or the like.

The display control unit 41 of the platform 26, for example, based on a request from the document preparation application 21, the plug-in application 24 or the like, controls the display of the display device 502. The setting unit 42 performs a setting for the plug-in application 24. The communication unit 43 executes the communication with the print server device 14 or the like. The storage unit 27 stores the settings or the like.

The client terminal 16, by integrating functions commonly used by the plug-in application 24 in the platform 26, integrates the processing. Meanwhile, a classification form in the processing block diagram in FIG. 3 is an example, and the hierarchical classification shown in FIG. 3 is not indispensable.

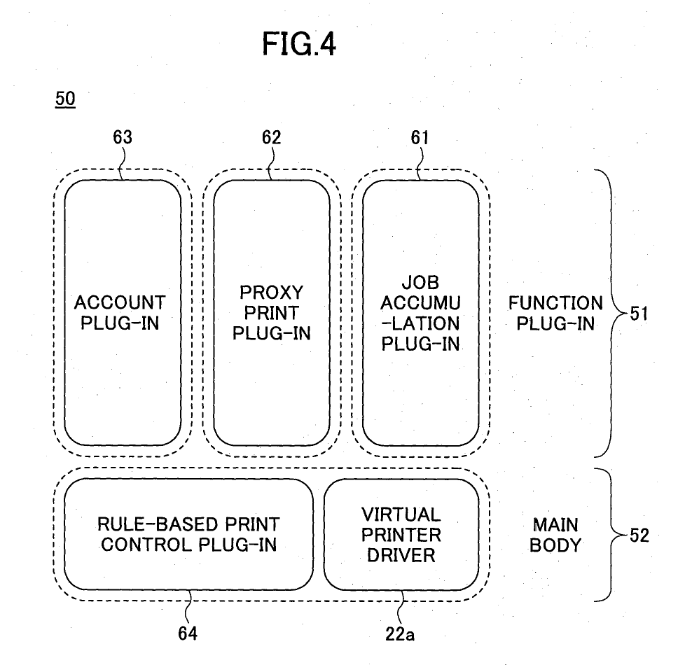

Moreover, the plug-in application 24 can be installed, for example, by using a software package 50 as shown in FIG. 4 from the application server device 12, and setting data for each plug-in application 24 can be installed in the same way as above.

FIG. 4 is a diagram illustrating an example of a configuration of the software package 50 according to the present embodiment. As shown in FIG. 4, the software package 50 includes a function plug-in 51, a main body 52 and a virtual printer driver 22a.

The main body 52 includes a rule-based print control plug-in 64. Moreover, the function plug-in 51 includes an independent job accumulation plug-in 61, a proxy print plug-in 62 and an account plug-in 63. The job accumulation plug-in 61, the proxy print plug-in 62 and the account plug-in 63 can be used by being arbitrarily added. That is, wholeness of these three plug-ins is not indispensable, and only the desired plug-in may be selected and provided as a software package.

Meanwhile, FIG. 4 shows an example of the software package 50 which is divided into the function plug-in 51 and the main body 52. However, dividing as in FIG. 4 is not indispensable. The software package 50 may be provided in one plug-in, or the plug-ins may be divided in a different way from FIG. 4. For example, the software package 50 may handle the main body 52 in parallel with the function plug-in 51 as a plug-in. The virtual printer driver 22a is not indispensable for the software package 50, and may be provided separately from the software package 50.

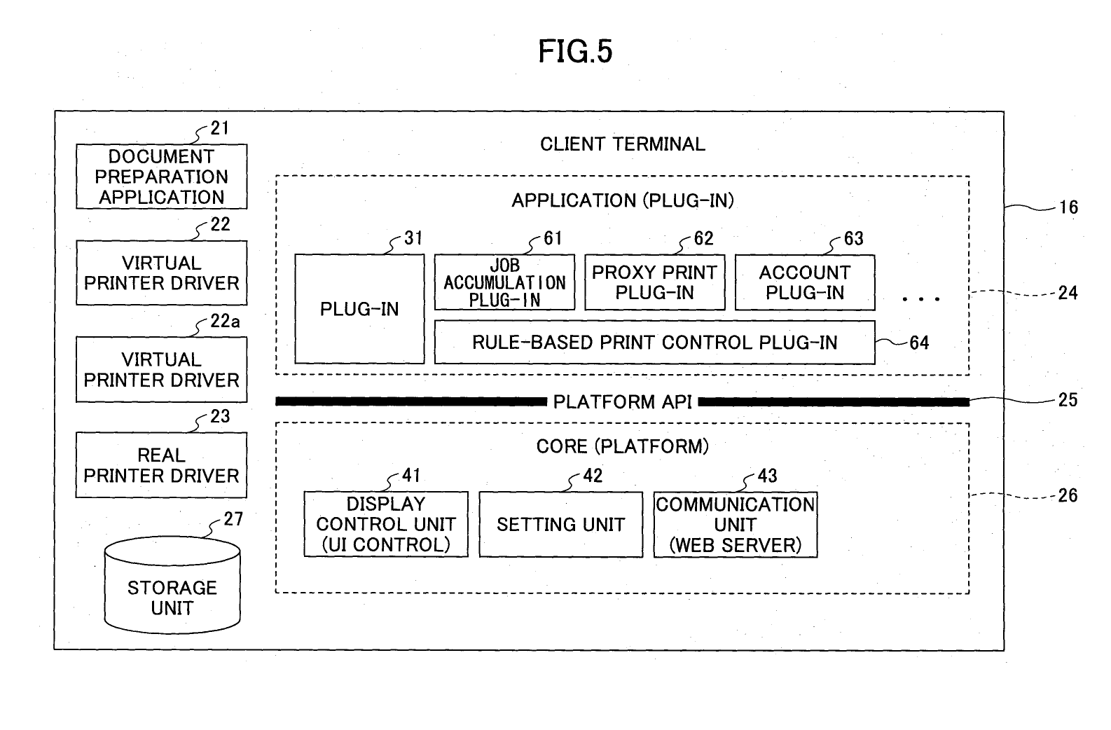

Moreover, the client terminal 16 after the software package 50 according to the present embodiment has been installed is realized by a processing block diagram as shown in FIG. 5, for example. FIG. 5 is a processing block diagram illustrating an example of the client terminal 16 after installing the software package according to the present embodiment. The client terminal 16 as shown in FIG. 5 indicates an example where the software package 50 shown in FIG. 4 is installed on the client terminal 16 shown in FIG. 3.

The client terminal shown in FIG. 5 has a configuration in which the virtual printer driver 22a, the job accumulation plug-in 61, the proxy print plug-in 62, the account plug-in 63 and the rule-based print control plug-in 64 are added to the client terminal 16 shown in FIG. 3.

The virtual printer driver 22a is an example of a virtual printer for using the job accumulation plug-in 61, the proxy print plug-in 62, the account plug-in 63 and rule-based print control plug-in 64, shown in FIG. 5. The virtual printer driver 22a converts application data into intermediate print data which is machine independent, and outputs the data.

Meanwhile, the intermediate print data are independent of a model of the output device 17 or the like. Data in XPS (XML Paper Specification) format is an example of the intermediate print data. Moreover, the application data are an example of data to be output.

The rule-based print control plug-in 64 performs a print flow control job. The job accumulation plug-in 61 performs a process regarding an accumulation of print jobs. The proxy print plug-in 62 performs a process regarding a proxy print job (proxy output). Moreover, the account plug-in 63 performs a process regarding an account. For example, in an output process performed at the local output device 15, or in an output process for performing an output to the output device 15 without going through the print server device 14, the account plug-in 63 generates account information and performs a process for sending it to a device that stores an account log.

Meanwhile, since the plug-in application 24, which an administrator or a user desires, can be arbitrarily installed and used, the configuration is not limited to that shown in FIG. 5.

<<Rule-Based Print Control Plug-in>>

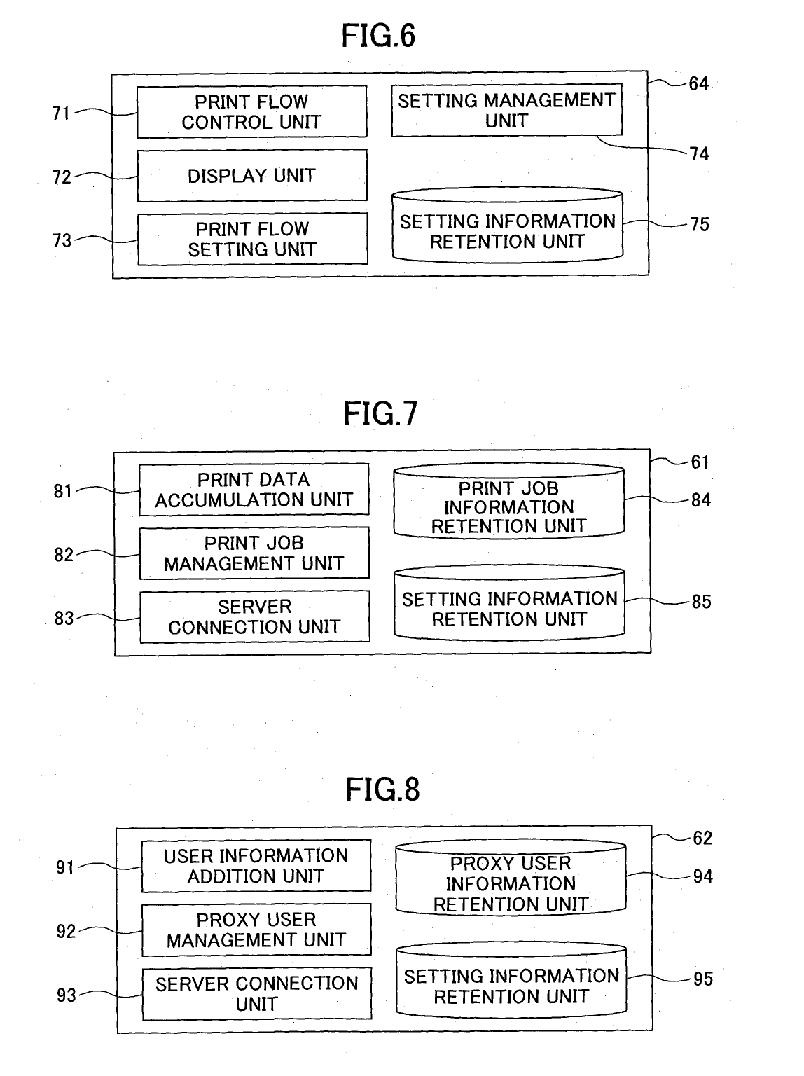

The rule-based print control plug-in 64 in the client terminal 16 is realized by the processing block diagram shown in FIG. 6, for example. FIG. 6 is a processing block diagram illustrating an example of a rule-based print control plug-in. The rule-based print control plug-in 64 shown in FIG. 6 includes a print flow control unit 71, a display unit 72, a print flow setting unit 73, a setting management unit 74 and a setting information retention unit 75.

The print flow control unit 71 controls an execution of a print flow (processing flow). The display unit 72 displays a function selection screen, which will be described later, on the display device 502 or the like. The print flow setting unit 73 receives a setting for the print flow.

The setting management unit 74 manages various settings for the respective plug-in applications 24 installed in the client terminal 16 by, for example, the software package 50 shown in FIG. 4. For example, content which can be set is changed depending on a situation of the function plug-in 51 to be added, but the setting management unit 74 manages content to be set. The setting information retention unit 75 retains information for setting (information regarding setting items) with which the rule-based print control plug-in 64 performs the setting for itself. Meanwhile, contents that have been actually set are stored in the storage unit 27 by the setting unit 42 of the platform 26, as described later.

<<Job Accumulation Plug-in>>

The job accumulation plug-in 61 of the client terminal 16 is realized by the processing block diagram as shown in FIG. 7, for example. FIG. 7 is a processing block diagram illustrating an example of a job accumulation plug-in. The job accumulation plug-in 61 shown in FIG. 7 includes a print data accumulation unit 81, a print job management unit 82, a server connection unit 83, a print job information retention unit 84 and a setting information retention unit 85.

The print data accumulation unit 81 accumulates print data in the storage unit 27 or the like. The print job management unit 82 manages print jobs. The server connection unit 83 performs connection to the authentication server device 13 or the print server device 14. The print job information retention unit 84 retains print job information which is information regarding the print job. The setting information retention unit 85 retains information for setting (information regarding setting items) with which the job accumulation plug-in 61 performs the setting for itself.

<<Proxy Print Plug-in>>

The proxy print plug-in 62 of the client terminal 16 is realized by the processing block diagram as shown in FIG. 8, for example. FIG. 8 is a processing block diagram illustrating an example of a proxy print plug-in. The proxy print plug-in 62 shown in FIG. 8 includes a user information addition unit 91, a proxy user management unit 92, a server connection unit 93, a proxy user information retention unit 94 and a setting information retention unit 95.

The user information addition unit 91 adds proxy user information such as a proxy user ID to the print job information. The proxy user management unit 92 manages proxy user information. The server connection unit 93 performs connection to the authentication server device 13 or the like. The proxy user information retention unit 94 retains proxy user information which is information regarding the proxy user. Moreover, the setting information retention unit 95 retains information for setting (information regarding setting items) with which the proxy print plug-in 62 performs the setting for itself.

<<Account Plugin>>

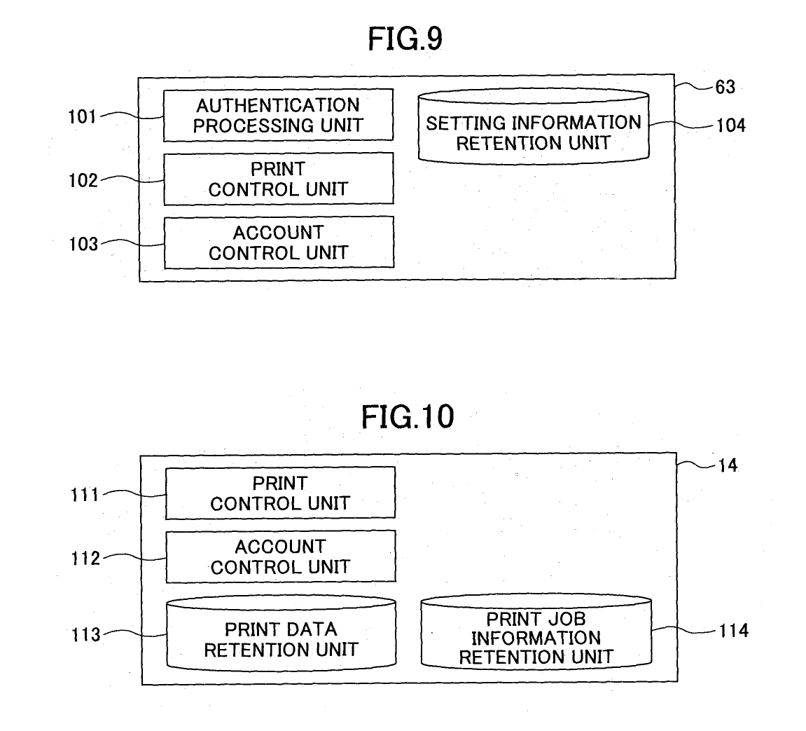

The account plug-in 63 of the client terminal 16 is realized by the processing block diagram as shown in FIG. 9, for example. FIG. 9 is a processing block diagram illustrating an example of the account plug-in 63. The account plug-in 63 as shown in FIG. 9 includes an authentication processing unit 101, a print control unit 102, an account control unit 103 and a setting information retention unit 104.

The authentication unit 101 performs a process regarding the authentication. The print control unit 102 performs a process regarding the print control. The account control unit 103 performs a process regarding the account control. Moreover, the setting information retention unit 104 retains information for setting (information regarding setting items) with which the account plug-in 63 performs the setting for itself.

<<Print Server Device>>

The print server device 14 according to the present embodiment is realized by the processing block diagram as shown in FIG. 10, for example. FIG. 10 is a processing block diagram illustrating an example of the print server device 14 according to the present embodiment. The print server device 14 shown in FIG. 10 realizes, by executing a program, a print control unit 111, an account control unit 112, a print data retention unit 113 and a print job information retention unit 114.

The print data retention unit 113 retains print data. The print job information retention unit 114 retains print job information. The print control unit 111 receives a request for print job information from the output device 17 or the like, and provides the print job information to the output device 17 or the like. Moreover, the print control unit 111 receives a request for print data from the output device 17 or the like, and provides print data retained by the print data retention unit 113 to the output device 17 or the like.

The account control unit 112 receives account information of print data executed based on print job information from the output device 17, and sends the account information of the print data to an account storage unit of the authentication server device 13 and stores it in the account storage unit. Meanwhile, the account control unit 112 may store the account information of the print data in a unit other than the account storage unit of the authentication server device 13.

<<Print Job Information>>

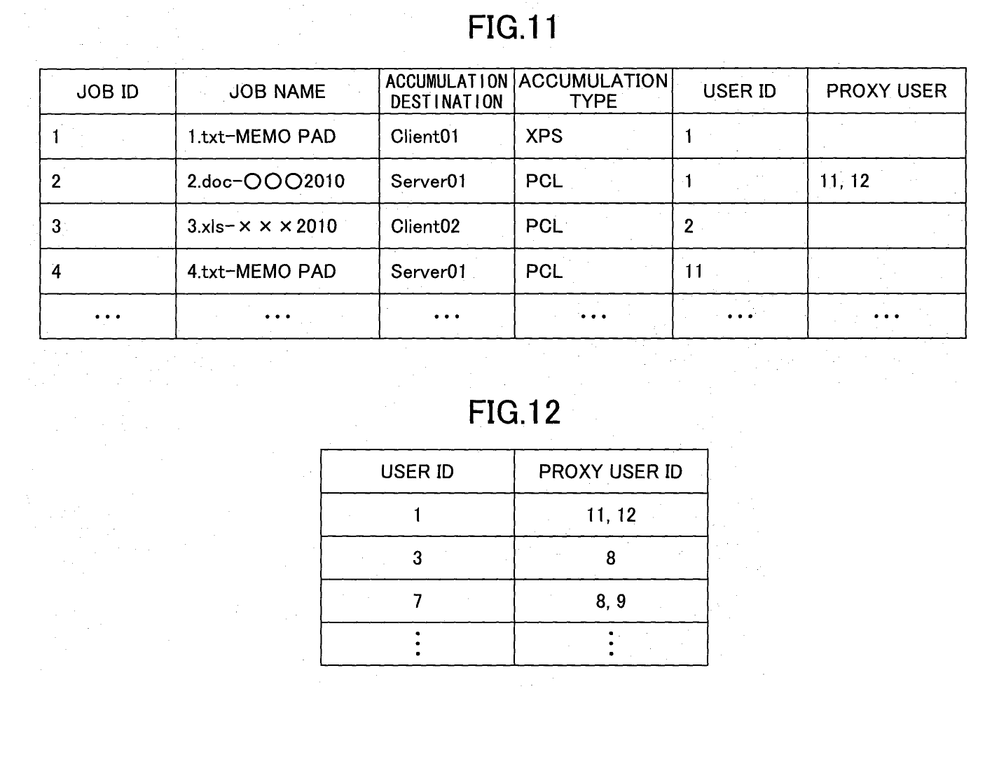

FIG. 11 is a diagram illustrating an example of a configuration of print job information. The print job information shown in FIG. 11 includes data items such as a job ID, a job name, an accumulation destination, an accumulation type, a user ID or a proxy user. ID.

The job ID is discrimination information of the print job. The job name is a name of the print job. The accumulation destination indicates a place where intermediate print data or real print data are accumulated. For example, in the case where the accumulation destination is “Server 01”, the real print data are accumulated in the print server device 14.

Meanwhile, the print server device 14 may receive the intermediate print data and accumulate the intermediate print data. When the print server device 14 is required to provide real print data by the output device 17 or the like, the print server device 14 may convert the intermediate print data into real print data as necessary, and may provide the real print data.

In the case where the accumulation destination is “Client 01” or “Client 02”, the intermediate print data or the real print data are accumulated in the client terminal 16 specified by “Client 01” or “Client 02”. For example, the output device 17 controls a request destination of the print data according to the print job information shown in FIG. 11.

The accumulation type indicates a type of print data accumulated in the accumulation destination. In the print job information shown in FIG. 11, in the case where the accumulation type is “XPS”, it indicates that intermediate print data are accumulated in the accumulation destination, and in the case where the accumulation type is “PCL”, it indicates that real print data are accumulated in the accumulation destination.

Meanwhile, the intermediate print data are print data, a common specification regarding the format of which has been open to the public and a data format of which can be easily reedited. Moreover, the data format of the intermediate print data is not limited to the XPS (XML Paper Specification). For example, the data format for the intermediate print data may be the PDF (Portable Document Format) or the like.

On the other hand, the real print data are print data in PDL (Page Description Language) depending on the output device 17 or the like. The data format of the real print data is not limited to the PCL (Printer Control Language). For example, the data format of the real print data may be the PS (PostScript) or the like.

The user ID is user discrimination information indicating an owner of the print data. The proxy user ID is a user ID of a proxy user who can print the print job. For example, in the case where a user with user ID “11” logged in, on the display device of the output device 17 such as the operation panel, a print job with a job ID of “4”, an owner of which is the user with the user ID of “11” and a print job with a job ID of “2” which is set as a proxy user.

<<Proxy User Information>>

FIG. 12 is a diagram illustrating an example of a configuration of proxy user information. The proxy user information is information for connecting the user ID and the proxy user ID. For example, FIG. 12 shows that as the proxy user for the user with user ID “1”, users with user ID “11” and “12” are set.

<Detail of Processing>

The processing of the print system 1 according to the present embodiment will be explained in detail in the following.

<<Basic Setting>>

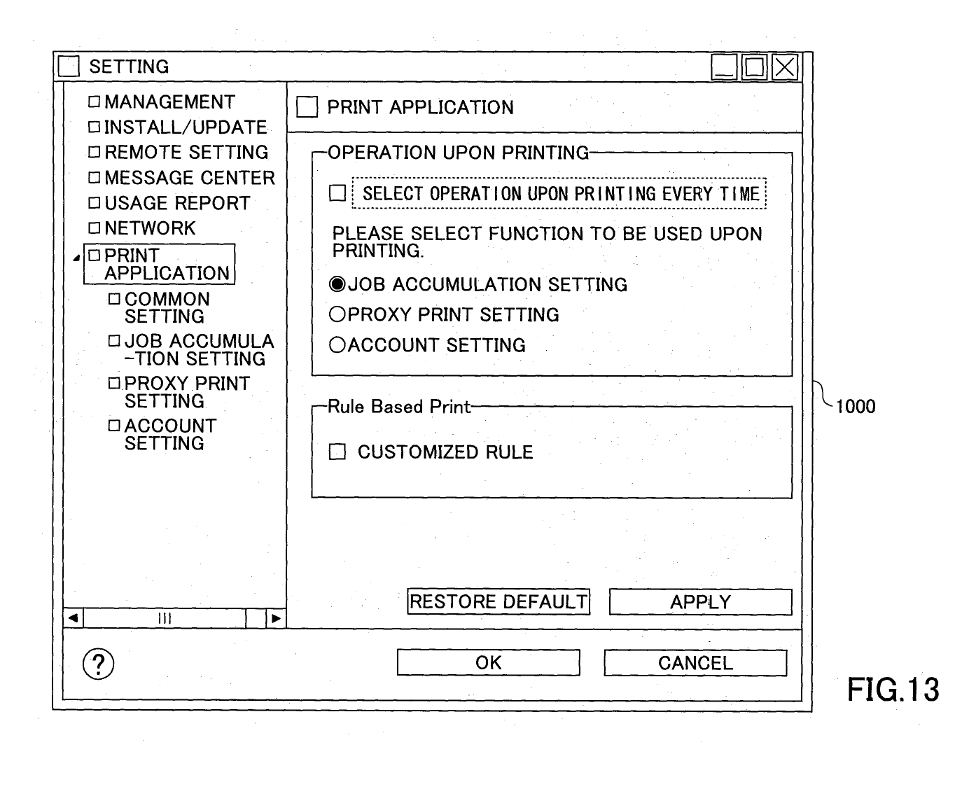

The client terminal 16, on which the software package 50 according to the present embodiment is installed, receives a basic setting for operation upon printing from a basic setting screen 1000 as shown in FIG. 13. FIG. 13 is an image drawing illustrating an example of the basic setting screen 1000. In the basic setting screen 1000 shown in FIG. 13, the software package 50 according to the present embodiment is described as “print application”. In the following, the software package 50 according to the present embodiment will be called “print application”.

FIG. 13 shows an example of the basic setting screen 1000 having three function plug-ins 51, i.e. the job accumulation plug-in 61, the proxy print plug-in 62 and the account plug-in 63. Accordingly, in the left column in the basic setting screen 1000 in FIG. 13, child nodes “job accumulation setting”, “proxy print setting” and “account setting” corresponding to the job accumulation plug-in 61, the proxy print plug-in 62 and the account plug-in 63, respectively, under the print application. Moreover, since the number of the function plug-ins 51 is greater than or equal to one, in the left column in the basic setting screen 1000 in FIG. 13, a child node “common setting” is displayed below the print application. FIG. 13 shows an example of the basic setting screen 1000 where the “print application” in the left column in FIG. 13 is selected.

Moreover, the right column of the basic setting screen 1000 in FIG. 13 includes a check box for setting whether to select a function upon printing. The check box whether to select a function upon printing is hidden when the number of the function plug-ins 51 is zero or one.

Moreover, the right column of the basic setting screen 1000 in FIG. 13 includes radio buttons for selecting a function which is executed upon printing. The radio buttons for selecting the function which is executed upon printing are hidden when the number of the function plug-ins 51 is zero or one. Moreover, the right column of the basic setting screen 1000 in FIG. 13 includes a check box for setting whether to execute a work flow by a customized rule file upon printing.

Meanwhile, in the case where the number of the function plug-ins 51 is two or more, when a user uninstalls the function plug-in 51 selected as the “function executed upon printing”, the basic setting screen 1000 in FIG. 13 operates according to the number of the remaining function plug-ins 51, as follows:

When the number of the remaining function plug-ins 51 is two or more, the “function executed upon printing” is automatically selected from the remaining function plug-ins 51 as the “function executed upon printing” according to an order of priority. For example, the order of priority may be set in the order of the job accumulation plug-in 61, the proxy print plug-in 62 and the account plug-in 63. When one function plug-in 51 remains, the remaining function plug-in 51 as the “function executed upon printing” is automatically selected as the “function executed upon printing”.

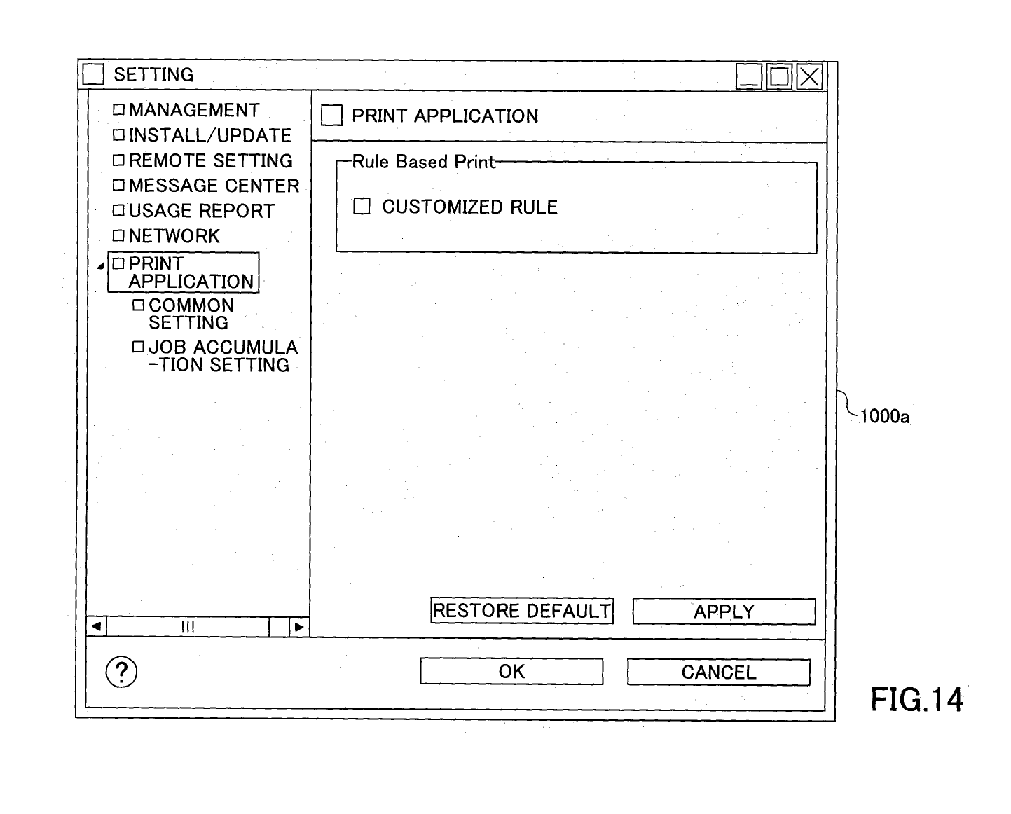

When the number of the function plug-ins 51 is one, the basic setting screen 1000 in FIG. 13 changes to the basic setting screen 1000a in FIG. 14. FIG. 14 is an image drawing illustrating another example of the basic setting screen. The basic setting screen 1000a in FIG. 14 shows an example where the function plug-in 51 is only the job accumulation plug-in 61 (the number of the plug-ins is one).

Accordingly, in the left column of the basic setting screen 1000a in FIG. 14, the child node “job accumulation setting” corresponding to the job accumulation plug-in 61 is displayed below the print application. Moreover, since the number of the function plug-ins 51 is greater than or equal to one, in the left column of the basic setting screen 1000a in FIG. 14, the child node “common setting” is displayed below the print application. Moreover, the right column of the basic setting screen 1000a in FIG. 14 includes a check box for setting whether to execute the work flow by the customized rule file upon printing.

Meanwhile, since the basic setting screen 1000a in FIG. 14 corresponds to the case where the number of the function plug-ins 51 is zero or one, the check box for setting whether to select function upon printing and the radio button for selecting function executed upon printing are hidden.

<<Server Setting>>

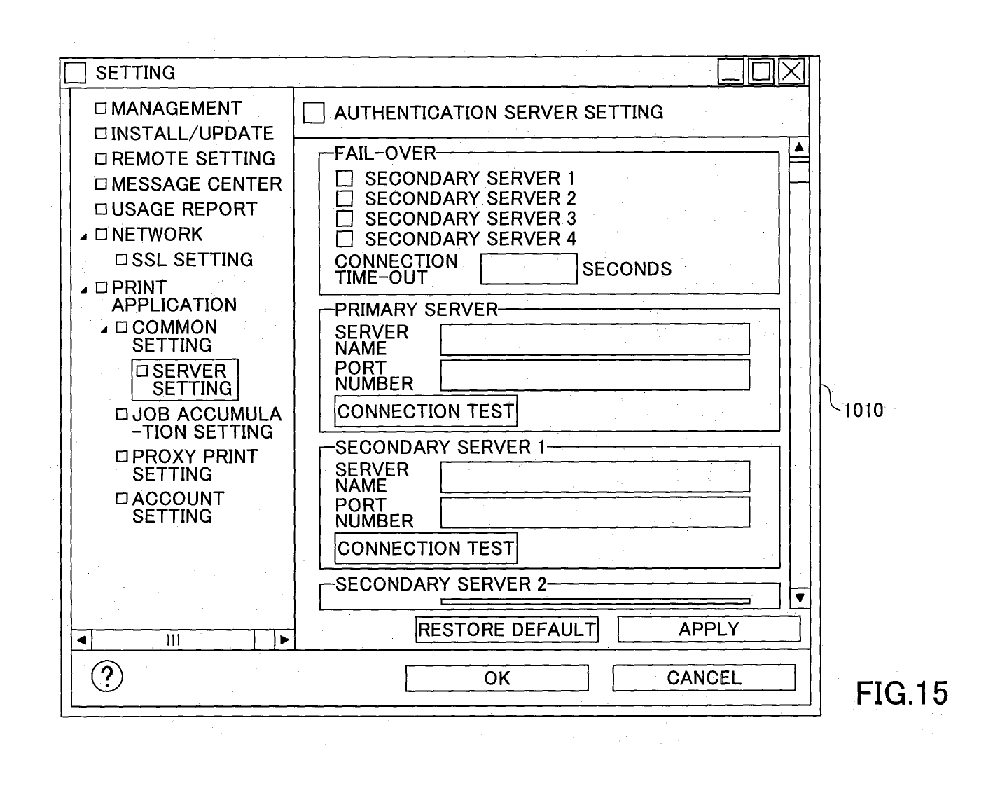

When the “common setting” in the left column of the basic setting screen 1000 in FIG. 13 is selected, the client terminal 16 receives from the server setting screen 1010 shown in FIG. 15 a server setting for the authentication server device 13 and the print server device 14. FIG. 15 is an image drawing illustrating an example of the server setting screen 1010.

Meanwhile, although in the server setting screen 1010 shown in FIG. 15, only a part for receiving the server setting for the authentication server device 13 is shown, a part for receiving the server setting for the print server device 14 can be shown by operating a vertical scroll bar.

In the right column of the server setting screen 1010 shown in FIG. 15, items for performing the server setting for the authentication server device 13 and the print server device 14 are shown. At first, the right column of the server setting screen 1010 includes a check box for setting a secondary server for the authentication server device 13 and the print server device 14 which becomes valid while a fail-over operates. When the check box for setting the secondary server being valid when the fail-over operates is ticked off, a setting column of the selected secondary server becomes valid.

Moreover, the right column of the server setting screen 1010 includes an edit box for setting as a connection time-out a time for waiting for a response from the authentication server device 13 or the print server device 14 which is a primary server by the print application.

Moreover, the right column of the server setting screen 1010 includes a setting column for the primary server and the secondary server of the authentication server device 13 and the print server device 14. The setting column for the primary server and the secondary server of the authentication server device 13 includes an edit box for setting an IP address or a host name and an edit box for setting a HTTPS port number. Moreover, the setting column for the primary server and the secondary server of the authentication server device 13 includes a connection test button for confirming a connection to the authentication server device 13 by the IP address or the host name and the HTTPS port number set in the edit boxes.

The setting column for the primary server and the secondary server of the print server device 14 includes an edit box for setting an IP address or a host name and an edit box for setting a port number.

Moreover, the setting column for the primary server and the secondary server of the print server device 14 includes a check box for setting whether to use the SSL communication for accessing the print server device 14. Moreover, the setting column for the primary server and the secondary server of the print server device 14 includes a connection test button for confirming a connection to the print server device 14 by the IP address or the host name and the port number set in the edit boxes.

<<Job Accumulation Setting>>

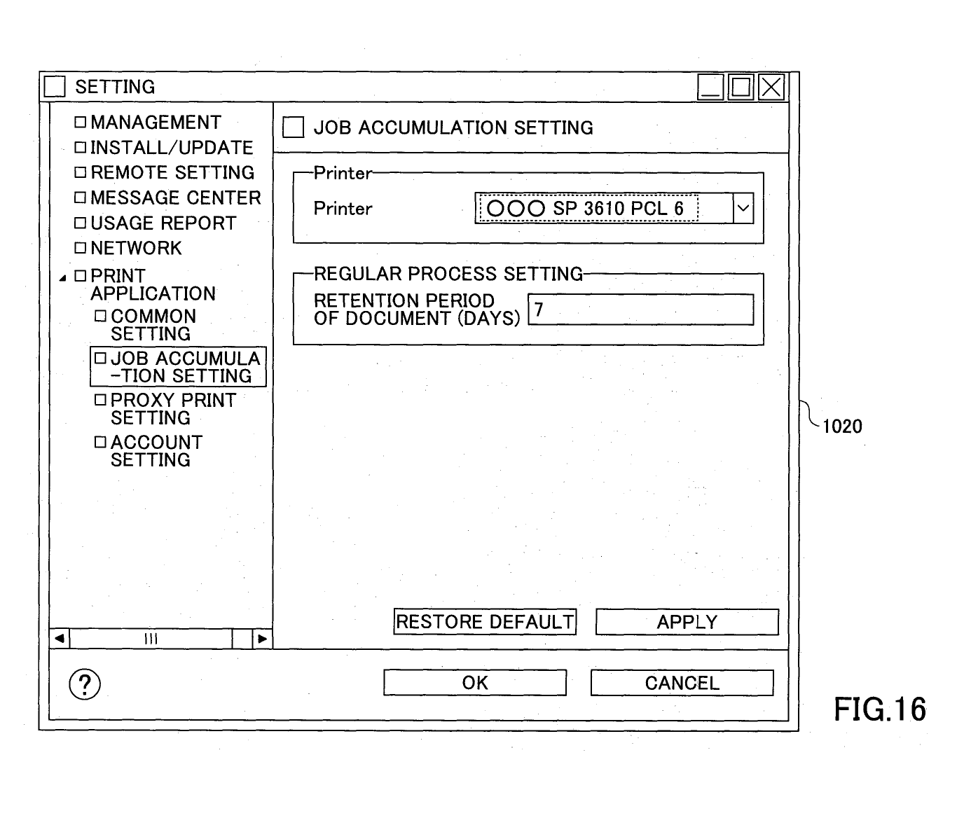

When the “Job accumulation setting” in the left column of the basic setting screen 1000 in FIG. 13 is selected, the client terminal 16 receives from a job accumulation setting screen 1020 shown in FIG. 16 a job accumulation setting. FIG. 16 is an image drawing illustrating an example of the job accumulation setting screen 1020.

A right column of the job accumulation setting screen 1020 includes a combo box for setting a printer driver used in the client terminal 16 for spooling rendered print data. Moreover, the right column of the job accumulation setting screen 1020 includes a text box for setting a retention period for accumulated print jobs (documents). A document beyond the retention period is deleted.

<<Proxy Print Setting>>

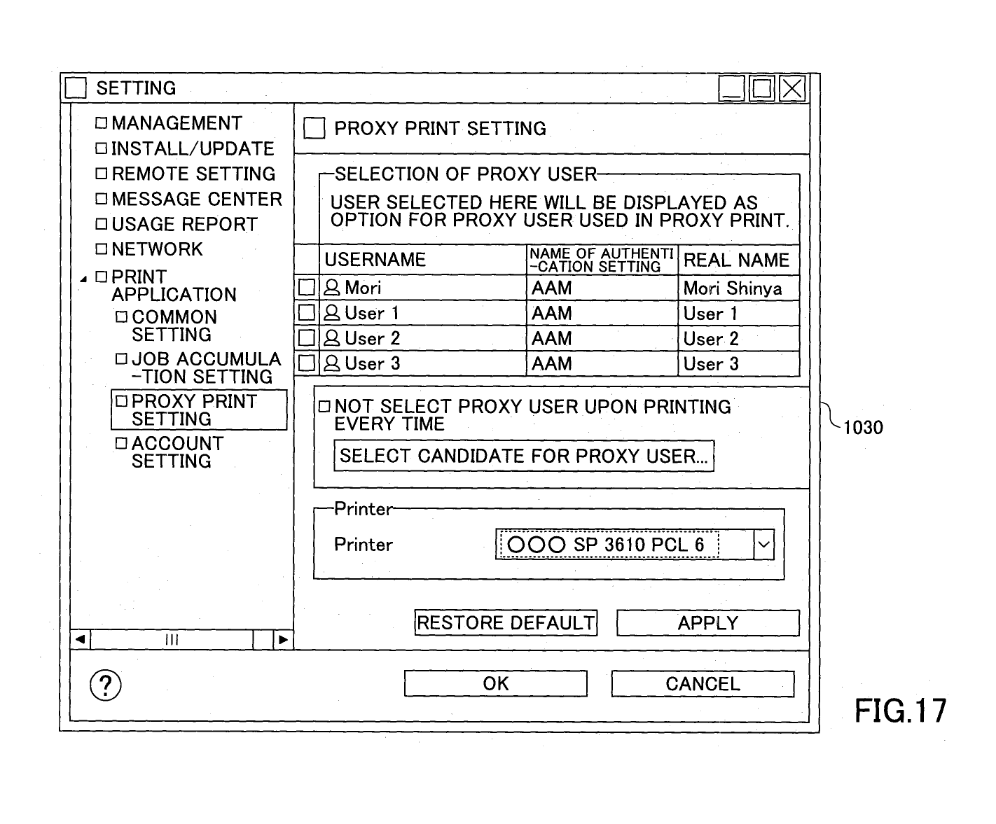

When the “proxy print setting” in the left column of the basic setting screen 1000 in FIG. 13 is selected, the client terminal 16 receives from a proxy print setting screen 1030 shown in FIG. 17 a proxy print setting. FIG. 17 is an image drawing illustrating an example of the proxy print setting screen 1030.

A right column of the proxy print setting screen 1030 includes a proxy user candidate list in which proxy user candidates are displayed in a list with check boxes. Moreover, the right column of the proxy print setting screen 1030 includes a check box for setting display/non-display of a proxy user selection dialogue which is displayed for every print job. The check box for setting display/non-display of a proxy user selection dialogue shown in FIG. 17, when it is checked, indicates a setting of not selecting a proxy user upon printing every time.

When the check box for setting display/non-display of the proxy user selection dialogue is checked, the proxy user selection dialogue is not displayed on the client terminal 16, and a user who is checked in the proxy user candidate list is implicitly the proxy user.

Moreover, the right column of the proxy print setting screen 1030 includes a button for opening a dialogue for selecting a proxy user candidate by each user. Furthermore, the right column of the proxy print setting screen 1030 includes a combo box for setting a printer driver used in the print server device 14.

<<Account Setting>>

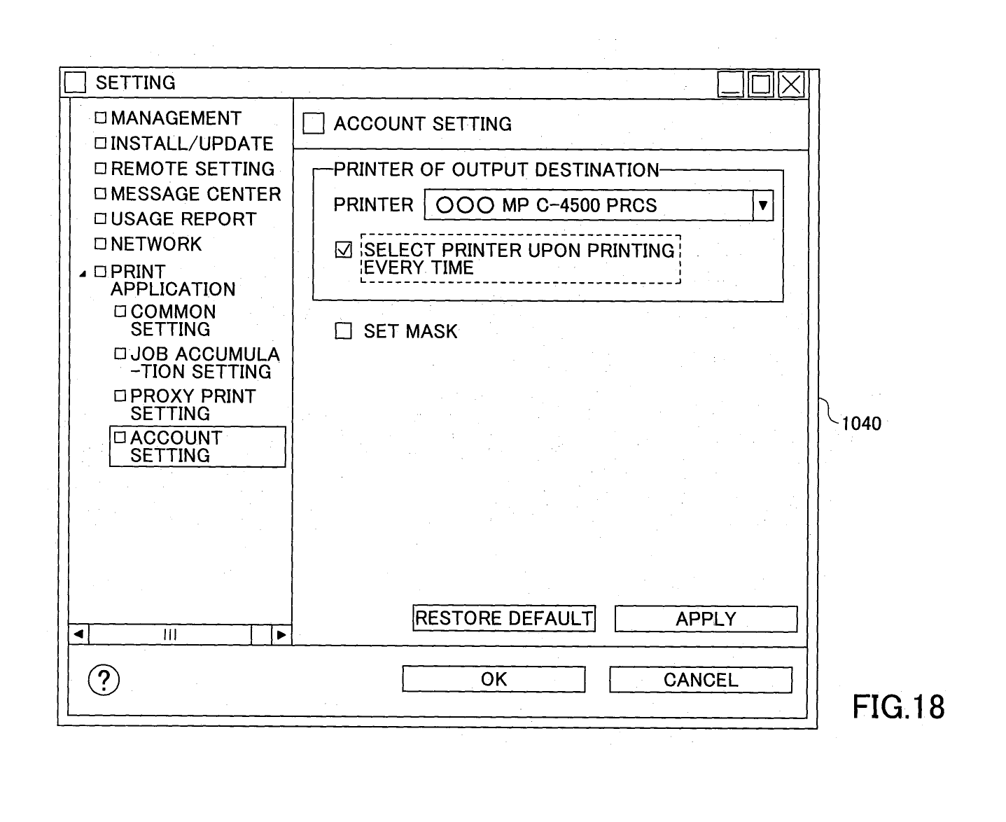

When the “account setting” in the left column of the basic setting screen 1000 in FIG. 13 is selected, the client terminal 16 receives from an account setting screen 1040 shown in FIG. 18 an account setting. FIG. 18 is an image drawing illustrating an example of the account setting screen 1040.

A right column of the account setting screen 1040 includes a combo box for selecting the output device 15 or the like used upon selecting a function of “printing to a specified printer” and printing with the account plug-in 63. In the combo box for selecting the output device 15 or the like used upon printing with the account plug-in 63, a list or printers registered in the OS is displayed.

However, from the list of printers displayed in the combo box, in order to avoid a double account, a virtual printer, a shared printer of the print server device 14 and a printer with a port of a direct print job are excluded.

The shared printer of the print server device 14 is a printer in which the print server device 14 is set as a transmission destination of print data. The printer with the port of the direct print job is a printer that sends print data by push to the output device 17 or the like via the print server device 14. In this way, from the list of printers displayed in the combo box, a printer of a print process which relays to the print server device 14 from input of print data to output is excluded.

This is because the print server device 14 has a function of sending account information to the authentication server device 13, and when account information of a printer of the print process for relaying to the print server device 14 is sent, double accounting may occur.

Moreover, the right column of the account setting screen 1040 includes a check box for setting whether to select a printer upon every printing. Furthermore, the right column of the account setting screen 1040 includes a check box for setting whether to mask a username displayed on a report. According to the mask setting, protection of privacy can be strengthened.

<<Print Job Accumulation Processing>>

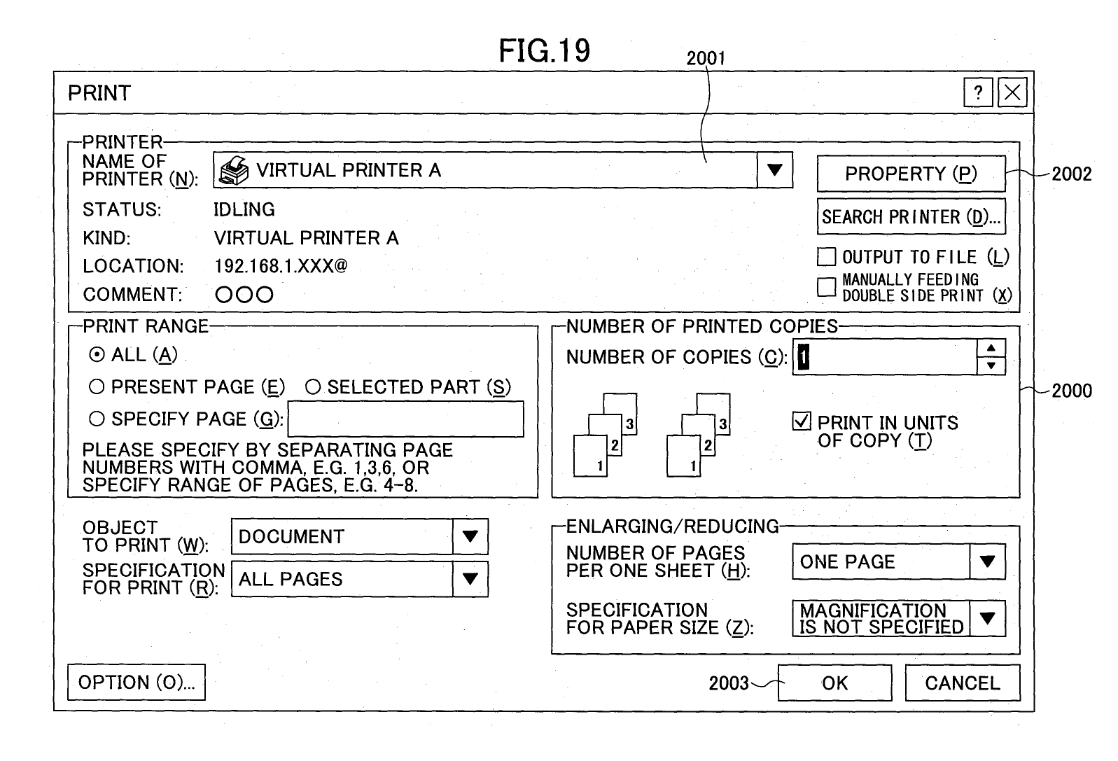

For example, a user can start a print job accumulation process by operating the document preparation application 21 to open a print setting screen 2000 shown in FIG. 19, and selecting the virtual printer driver 22a of the print application to require printing.

FIG. 19 is an image drawing illustrating an example of the print setting screen 2000. The user can select the virtual printer driver 22a from a printer selection column 2001 of the print setting screen 2000. Moreover, the user can also select the real printer driver 23, which executes printing directly to the local output device 15, from the printer selection column 2001 of the print setting screen 2000.

Meanwhile, from the print setting screen 2000 shown in FIG. 19, other than the virtual printer driver 22a of the print application according to the present embodiment, the virtual printer driver 22 for using other software such as the plug-in 31 can be selected. By selecting the virtual printer driver 22 and requiring printing, the user can start a process according to the selected virtual printer driver 22, such as a pull print job.

For example, in the case where the virtual printer driver 22 for the plug-in 31 for performing a pull print job is selected, after the virtual printer driver 22 converts application data into intermediate print data, the real printer driver 23 is required to convert into real print data. The real printer driver 23, with print job information, realizes the pull print job by sending the real print data to the print server device 14. In the case where the real printer driver 23 for performing the direct print is selected, the direct print job is realized by, after converting intermediate print data converted by the virtual printer driver 22 into real print data by the real printer driver 23, sending them to the output device 15 or the like.

Moreover, the user can specify a number of print copies from the print setting screen 2000. Furthermore, the user can perform a setting for print side, such as single sided/double sided, a setting for a color mode, such as color/monochrome, or a setting for integration, such as 2 in 1, by holding down a “property” button 2002 in the print setting screen 2000, to open a screen for performing a print setting in detail. And, the user can require printing by holding down an “OK” button 2003 in the print setting screen 2000.

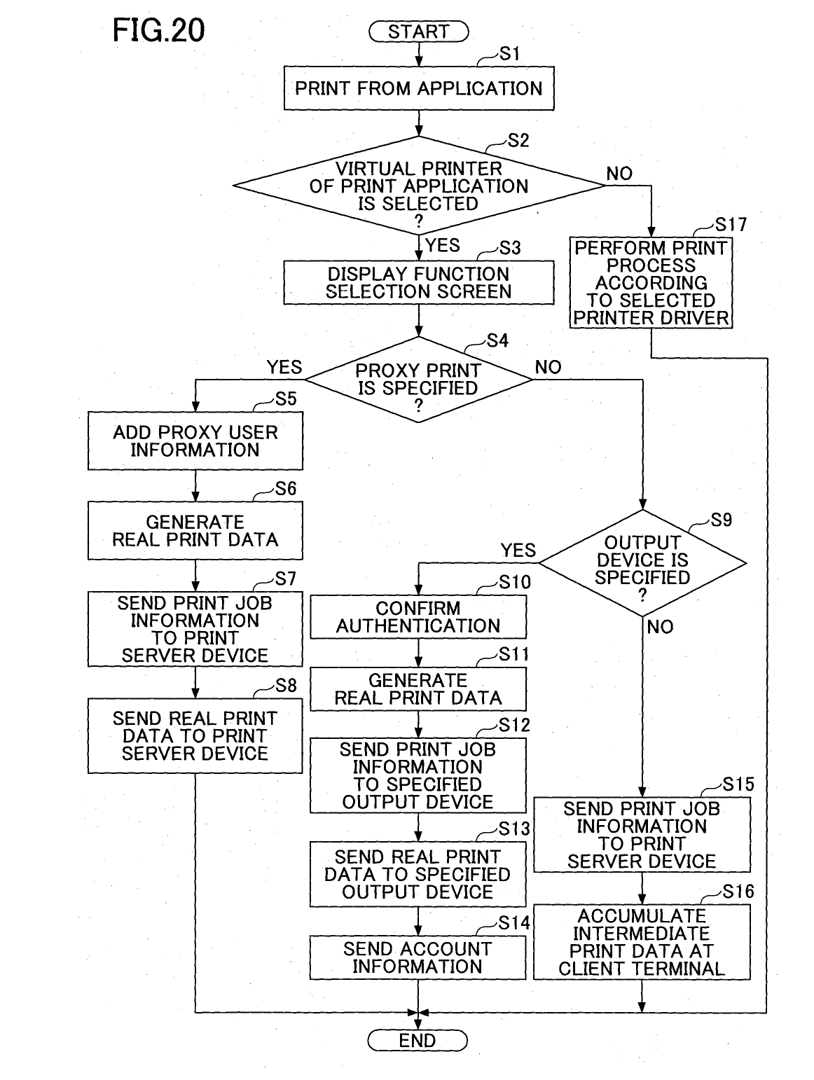

When the user selects the virtual printer driver 22a and requires printing, the client terminal 16 starts the print job accumulation process as shown in FIG. 20. FIG. 20 is a flowchart illustrating an example of the print job, accumulation process.

The document preparation application 21 receives a request for printing from the user (step S1). The document preparation application 21 determines whether the virtual printer driver 22a for the print application is selected from the printer selection column 2001 in the printer print setting screen 2000 is (step S2). In the case where a printer driver other than the virtual printer driver 22a for the print application is selected (step S2: NO), the process of the document preparation application 21 proceeds to step S17, and a notice of a print event is given to a printer driver such as the virtual printer driver 22 or the like selected by the user. Accordingly, the user can start the print process according to the selected printer driver 22, such as the pull printing.

The process of the document preparation application 21 proceeds to step S3 when the virtual printer driver 22a of the print application is selected, and the print event is sent to the virtual printer driver 22a. The virtual printer driver 22a sends the print event to the print flow control unit 71 in the rule-based print control plug-in 64. Moreover, the virtual printer driver 22a converts application data into intermediate print data.

In the case where in the right column of the basic setting screen 1000 in FIG. 3, a setting of executing a work flow by a customized rule file upon printing is selected, and the print flow control unit 71 ends the process shown in FIG. 20. Afterwards, the print flow control unit 71 does not display a function selection screen, which will be described below, and executes the work flow according to the rule file.

In the case where a setting of executing the work flow by the customized rule file upon printing is not selected and the number of the function plug-ins 51 is zero, the print flow control unit 71 ends the process shown in FIG. 20.

In the case where the setting of executing the work flow by the customized rule file upon printing is not selected and the number of the function plug-ins 51 is one, the print flow control unit 71 selects the function of the function plug-in 51.

In the case where the setting of executing the work flow by the customized rule file upon printing is not selected, the number of the function plug-ins 51 is two or more and a setting of selecting a function upon printing is not selected, the print flow control unit 71 does not display the function selection screen which will be described below. In this case, by a radio button for selecting a function which is executed upon printing, the selected function is selected.

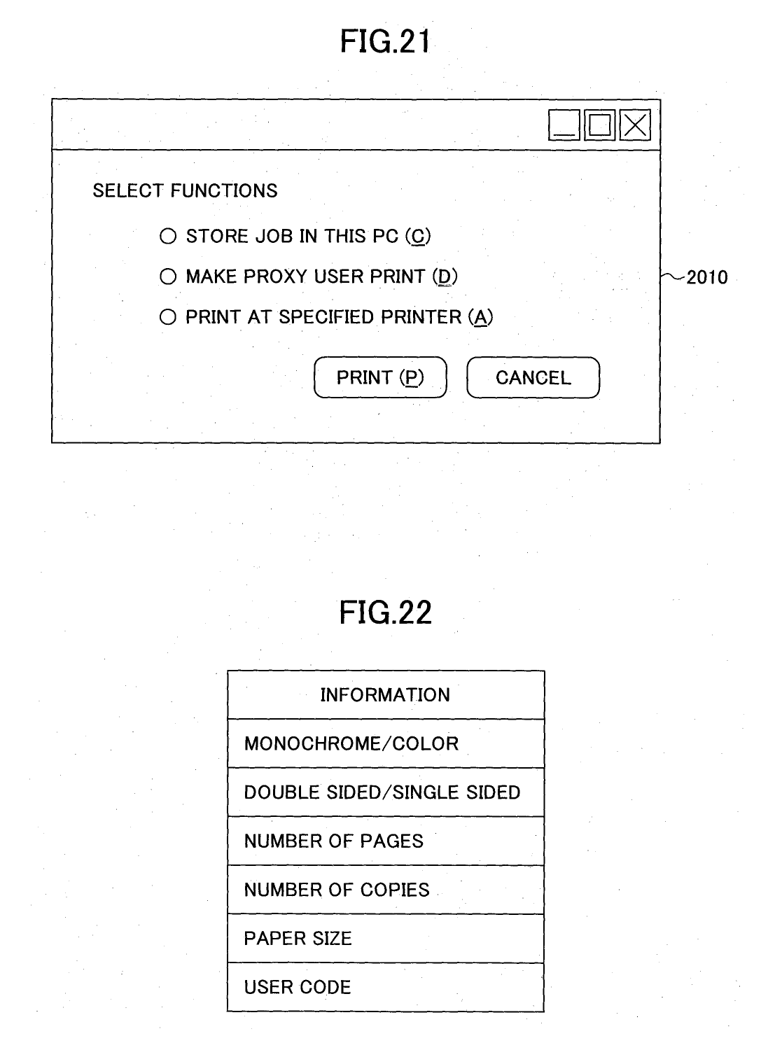

In the case where the setting of executing the work flow by the customized rule file upon printing is not selected, the number of the function plug-ins 51 is two or more and the setting of selecting a function upon printing is selected, the print flow control unit 71 displays a function selection screen 2010 on the display unit 72. FIG. 21 is an image drawing illustrating an example of the function selection screen 2010.

The function selection screen 2010 is an example in the case of the user selecting one function from a function of “storing a job in this PC”, a function of “making the proxy user print” and a function of “printing at the specified printer”. The function of “storing a job in this PC” is selecting the function of the job accumulation plug-in 61. The function of “making the proxy user print” is selecting the function of the proxy print plug-in 62. The function of “printing at the specified printer” is selecting the function of the account plug-in 63.

The user selects one function from the function of “storing a job in this PC”, the function of “making the proxy user print” and the function of “printing at the specified printer” (step S4). The print flow control unit 71 of the rule-based print control plug-in 64 determines the function that the user selects from the function selection screen 2010.

When the function that the user selects is the function of “making the proxy user print”, the print flow control unit 71 determines that the proxy print is selected. Moreover, when the function that the user selects is not the function of “making the proxy user print”, the print flow control unit 71 determines whether the function that the user selects is the function of “printing at the specified printer” or the function of “storing a job in this PC” (step S9).

When the proxy print is determined to be selected, the user information addition unit 91 of the proxy print plug-in 62 performs a process of step S5. When the proxy user selection dialogue which is displayed for every print job is set not to be displayed in step S5, the proxy user selection dialogue is not displayed and the proxy user checked in the proxy user candidate list is selected. The proxy user checked in the proxy user candidate list can be acquired from the proxy user information retention unit 94 as a proxy user ID connected to a user who requires printing (which will be called a print-requiring user, in the following).

On the other hand, when the proxy user selection dialogue which is displayed for every print job is set to be displayed in step S5, the user information addition unit 91 displays the proxy user selection dialogue, and makes the print-requiring user select the proxy user. The user information addition unit 91 adds a user ID of the print-requiring user and the proxy user ID to the print job information.

Meanwhile, as the user ID of the print-requiring user, for example, a user ID used when the user logs into the client terminal 16 may be used, or a user ID used upon authenticating by the authentication server 13 separately may be used. It can be set in advance which user ID is used.

The print data accumulation unit 81 of the job accumulation plug-in 61, using the real printer driver 23, generates real print data from intermediate print data (step S6). The print job management unit 82 manages the real print data as an object to be managed.

The server connection unit 83 sends the print job information to the print server device 14 (step S7). Moreover, the server connection unit 83 sends the real print data to the print server device (step S8).

When the function of “printing at the specified printer” is determined to be selected, the processing of the authentication processing unit 101 of the account plug-in 63 proceeds to step S10. The authentication processing unit 101 performs an authentication confirmation for the print-requiring user using the authentication server device 13 (step S10).

When the authentication confirmation for the print-requiring user is not successful, the print control unit 102 of the account plug-in 63 ends the processing in the flowchart shown in FIG. 20. When the authentication for the print-requiring user is successful, in the case where the setting of selecting a printer upon printing every time is selected in the right column in the account setting screen 1040 shown in FIG. 18, the print control unit 102 displays a screen for selecting a printer, and makes the user select the printer. Here, the printers to be selected are the same as the printers which can be selected in the “account setting”.

Moreover, in the case where the setting of selecting a printer upon printing every time is not selected, the print control unit 111 selects a printer selected by the combo box for selecting the output device 15 or the like which is used upon printing by the account plug-in 63.

The processing of the print control unit 111 of the account plug-in 63 proceeds to step S11, print job information and intermediate print data are sent to the real printer driver 23, and the real printer driver 23 is instructed to execute the print job. The real printer driver 23 generates real print data from the intermediate print data.

The real printer driver 23 sends the print job information to the specified output device 15 or the like (step S12). Moreover, the real printer driver 23 sends the real print data to the specified output device 15 or the like (step S13). The output device 15 or the like which has received the print job information and the real print data executes a print job and prints the real print data. The transmission of the print job information at step S12 is not indispensable, and may be omitted.

The processing proceeds to step S14, the account control unit 103 of the account plug-in 63 generates account information according to the printing of the real print data, and sends it to the authentication server device 13 which stores an account log.

FIG. 22 is a diagram illustrating an example of a configuration of the account information. The account information shown in FIG. 22 is an example of items of the account information of the real print data which are printed at the output device 15 or the like. As shown in FIG. 22, the account information includes, as items, information of monochrome/color of the real print data, information of double sided/single sided, information of number of pages, information of number of copies, information of paper size and information of user code.

The user code included in the account information corresponds to the user ID in the print job information shown in FIG. 11. Accordingly, in the case of the proxy print job, for the user code included in the account information, not the proxy user ID, but the user of the owner is set. Meanwhile, in the case of the proxy print job, the account information may include, other than the user code, user information of a user ID of the proxy user who has executed printing or the like.

When the function of “storing a job in this PC” is determined to be selected, the processing of the server connection unit 83 of the job accumulation plug-in 61 proceeds to step S15, and the print job information is sent to the print server device 14. Moreover, the print job management unit 82 of the job accumulation plug-in 61 accumulates intermediate print data in the print data storage unit 65 and manages them. Meanwhile, in the print job accumulation process shown in FIG. 20 illustrates an example of accumulating intermediate print data in the client terminal 16, but real print data may by accumulated in the client terminal 16.

According to the print job accumulation process shown in FIG. 20, the user can accumulate real print data in the print server device 14 by selecting the proxy print. For the real print data, content of the print setting which can be changed is limited, but according to a feature of the proxy print it is considered that there are few cases of changing the print setting during an execution of the print job.

Moreover, by accumulating real print data in the print server device 14, even if the power to the client terminal 16 is turned off, the proxy user can execute the print job.

According to the print job accumulation process shown in FIG. 20, by making the user select the function, a setting for accumulation, such as an accumulation destination or an accumulation format, can be easily changed according to the function.

Meanwhile, the setting of executing the work flow by the customized rule file upon printing is selected, the print flow control unit 71, according to the rule file, executes the work flow as follows:

For example, the print flow control unit 71 has a rule file which is a work flow definition file in XML along a predetermined format, and can realize the work flow according to the rule file. The rule file is edited in advance, and arranged at a predetermined position of the client terminal 16.

Meanwhile, in the print system 1 according to the present embodiment, a rule file arranged in the shared folder may be distributed to the client terminal 16 by the remote setting function. Moreover, in the print system 1 according to the present embodiment, releasing the setting of executing the work flow by the customized rule file upon printing may be prohibited.

For example, some rule files represent a work flow of distributing print jobs to plural output devices 17 or the like according to numbers of pages, a work flow of forcibly changing a color printing to a monochrome printing, a work flow of distributing print jobs to plural output devices 17 or the like according to job names, or the like. In addition to them, some rule files represent work flows or the like including any one of the functions of the job accumulating plug-in 61, the proxy print plug-in 62 and the account plug-in 63.

The rule file can be defined by combining a condition and an action. For the condition, a print setting of the print job information, such as a number of pages, a color setting or a name of job, is defined. For the action, a determination process, such as a print job, a change in a print setting, a distribution of process, is defined. In a rule file, plural conditions may be defined and a conditional branching may be defined.

<<Print Job Output Process>>

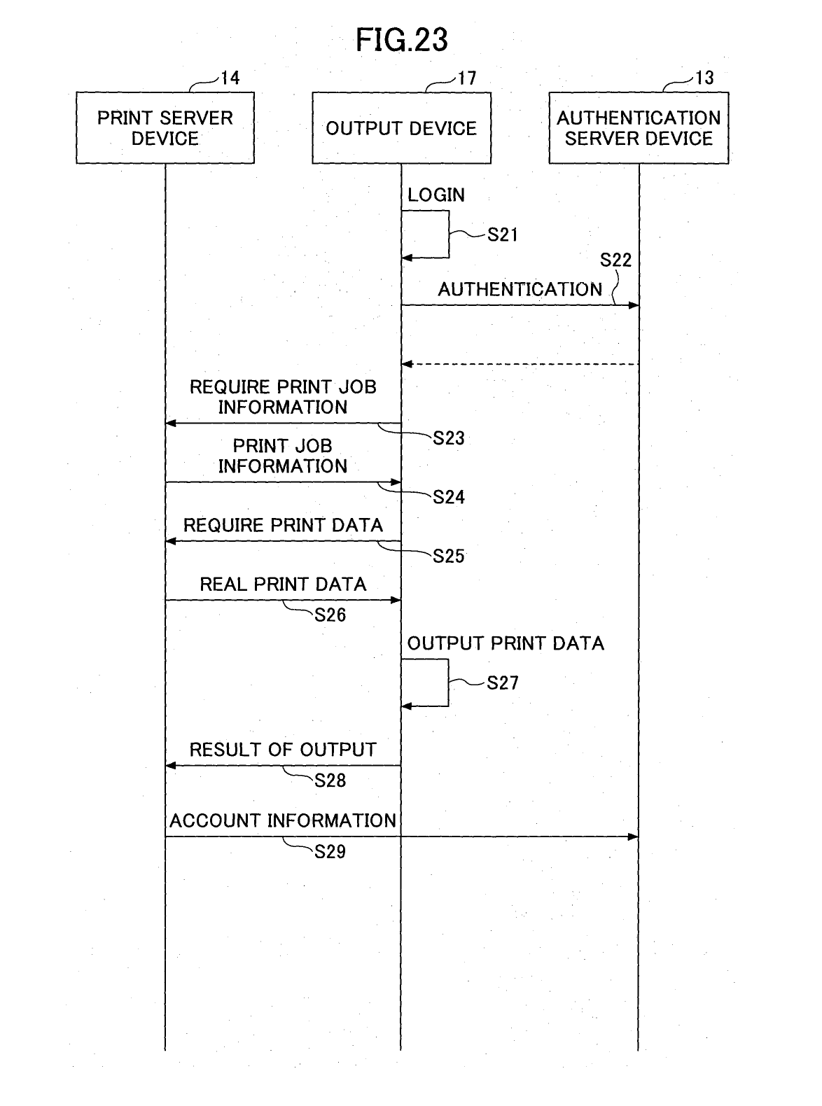

In the case of accumulating print data in the print server device 14, the print system 1 performs, for example, a print job output process shown in FIG. 23. FIG. 23 is a sequence diagram illustrating an example of the print job output process. Meanwhile, an example of executing a print job at the output device 17 will be explained here.

The user inputs authentication information from the operation panel or the like of the output device 17, to require a login (step S21). The output device 17 which has required the login sends the authentication information to the authentication server device 13, to request an authentication (step S22). The authentication server device 13 performs an authentication using the received authentication information, and returns a result of authentication to the output device 17. Here, the case where the authentication is successful will be explained. Meanwhile, in the case where the authentication is not successful, for example, the display device such as the operation panel displays that the login is not successful, and the processes after step S23 are not performed.

The output device 17 requires the print server device 14 to provide print job information of a user an authentication of whom was successful (step S23). The print server device 14 searches the print job information, to which a user ID of the user the authentication of whom was successful is given (step S24). The print server device 14 sends a list of the searched print job information to the output device 17.

The output device 17 displays the received list of the print job information, and makes the user select print job information from the list of the print job information. When the user selects print job information from the list of the print job information, the output device 17 can determine an accumulation destination of print data of the print job from an accumulation destination of the print job information selected by the user. Here, the print server device 14 is determined to be the accumulation destination of the print data. The output device 17 requires the print server device 14 to provide the print data of the print job selected by the user (step S25).

In the first embodiment, the print data accumulated in the print server device 14 are real print data. The print server device 14 sends the real print data of the print job required by the output device 17 to the output device 17 (step S26). The output device 17 outputs the received real print data (step S27).

The output device 17 sends account information as an output result of the real print data to the print server device 14 (step S28). The account control unit 112 of the print server device 14 sends the account information of the real print data to the account storage unit of the authentication server device 13 and stores it in the storage unit (step S29).

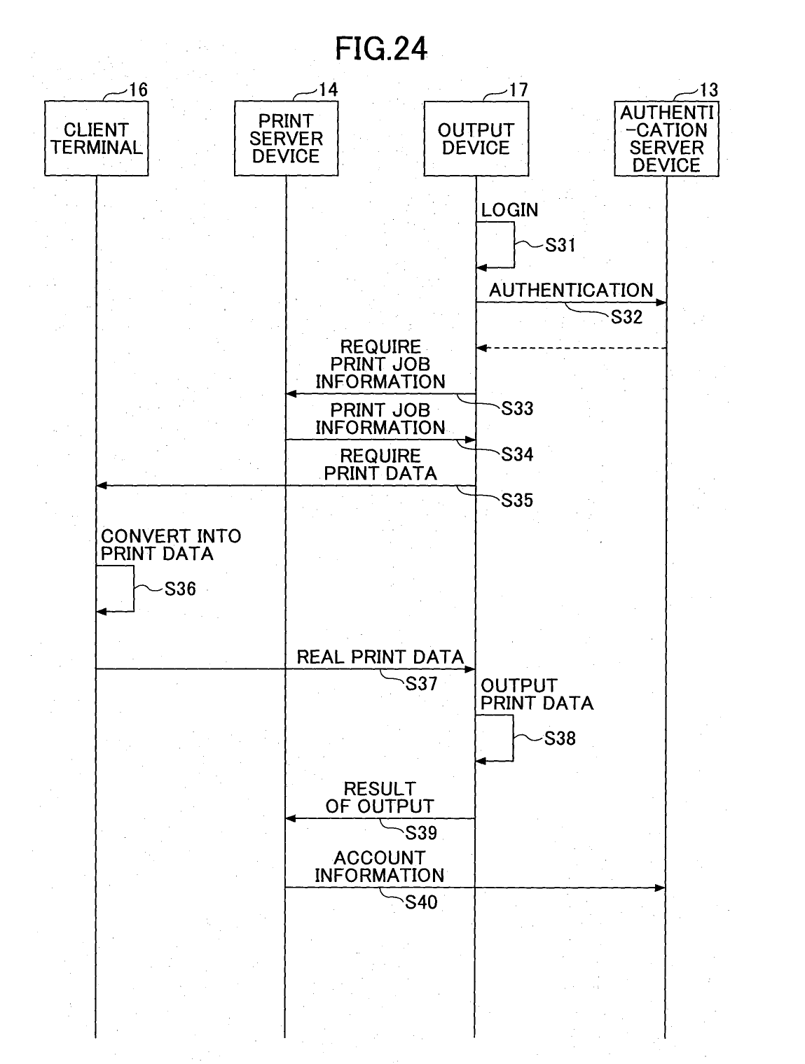

In the case of accumulating the print data in the client terminal 16, the print system 1 performs, for example, a print job output process shown in FIG. 24. FIG. 24 is a sequence diagram illustrating another example of the print job output process. Meanwhile, an example of executing a print job at the output device 17 will be explained here.

The user inputs authentication information from the operation panel or the like of the output device 17, to require a login (step S31). The output device 17 which has required the login sends the authentication information to the authentication server device 13, to require an authentication (step S32). The authentication server device 13 perform an authentication using the received authentication information, and returns a result of authentication to the output device 17. Here, the case where the authentication is successful will be explained. Meanwhile, in the case where the authentication is not successful, for example, the display device such as the operation panel displays that the login is not successful, and the processes after step S33 are not performed.

The output device 17 requires the print server device 14 to provide print job information of a user an authentication of whom was successful (step S33). The print server device 14 searches print job information, to which a user ID of the user the authentication of whom was successful is given (step S34). The print server device 14 sends a list of the search-located print job information to the output device 17.

The output device 17 displays the received list of the print job information, and makes the user select print job information from the list of the print job information. When the user selects print job information from the list of the print job information, the output device 17 can determine an accumulation destination of print data of the print job from an accumulation destination of the print job information selected by the user. Here, the client terminal 16 is determined to be the accumulation destination of the print data. The output device 17 requires the print server device 14 to provide the print data of the print job selected by the user (step S35).

In the first embodiment, the print data accumulated in the print server device 14 are intermediate print data. The print job management unit 82 of the job accumulation plug-in 61 of the client terminal 16, converts the intermediate print data into real print data using the real printer driver 23 (step S36). Meanwhile, the client terminal 16 may accumulate real print data in the client terminal 16. In this case, the process of step 36 will be omitted.

The client terminal 16 sends the real print data of the print job required by the output device 17 to the output device 17 (step S37). The output device 17 outputs the received real print data (step S38).

The output device 17 sends account information as an output result of the real print data to the print server device 14 (step S39). The account control unit 112 of the print server device 14 sends the account information of the real print data to the account storage unit of the authentication server device 13 and stores it in the storage unit (step S40).

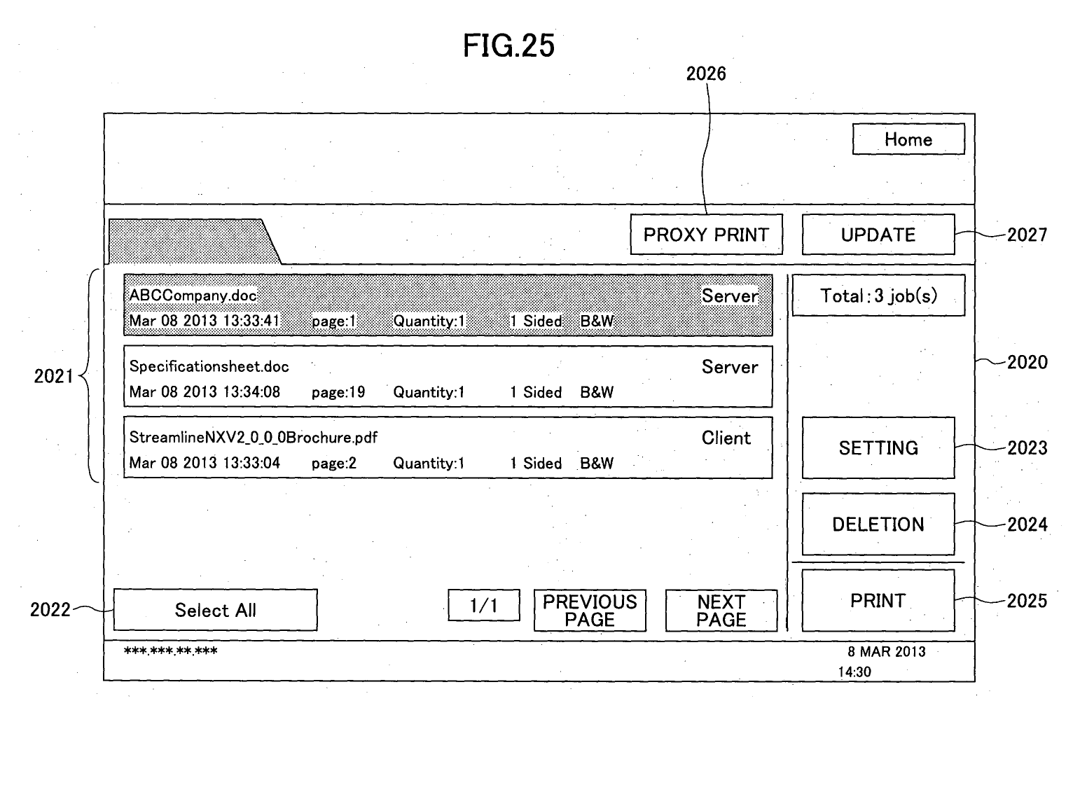

The output device 17 displays the received list of the print job information, for example, on the display device such as the operation panel, as shown in FIG. 25. FIG. 25 is an image drawing illustrating an example of the list screen of the print job information.

A print job information list screen 2020 shown in FIG. 25 includes a list of print job information 2021 of a user an authentication of whom has been successful. The list of the print job information 2021 is represented by a selectable part such as a button for each print job information item. In the part representing each print job information item in FIG. 25, a print job name, a time and date, a number of pages, a number of copies, a print surface, a color mode and an accumulation destination of the print data are shown as an example.

Moreover, the print job information list screen 2020 shown in FIG. 25 includes an all selection button 2022, a setting button 2023, a deletion button 2024, a print button 2025, a proxy print button 2026 and an update button 2027.

The all selection button 2022 is a button for selecting all the print job information of the list of the print job information 2021. The setting button 2023 is a button for displaying the print setting change screen of the print job information which is selected. The deletion button 2024 is a button for deleting the print job information which is selected. The print button 2025 is a button for requiring starting printing the print job information which is selected.

The proxy print button 2026 is a button for displaying print job information that can be printed by the login user as a proxy user. The update button 2027 is a button for updating the list of print job information 2021. When the update button 2027 is held down, the output device 17 reacquires the print job information from the print server device 14.

<<Software Update and Remote Setting>>

In the print system 1 according to the present embodiment, for example, the print application of the client terminal 16, automatically or by a user's instruction, confirms a software update at the application server device 12, and performs an update if software to be updated is found.

In the case of setting the print application to be updated automatically, for example, at the time of startup of the print application of the client terminal 16 a software update is confirmed at the application server device 12, and the update is performed if software to be updated is found.

When the user instructs confirmation of the software update by, for example, holding down an “update confirmation” button, the print application of the client terminal 16 confirms a software update at the application server device 12, and the update is performed if software to be update is found.

Moreover, in the print system 1 according to the present embodiment, an operation or a content of process of each of the functions operating on the print application can be changed by changing a setting for the function. Accordingly, in the print system 1 according to the present embodiment, there may be a case where, for a part of settings, content set by an administrator is desired to be reflected in the client terminal 16, not performing a setting for each user individually.

Accordingly, the print system 1 according to the present embodiment may be provided with, in addition to the function of performing various settings at the client terminal 16, a function of distributing various settings performed at the administrator terminal 11 from the application server device 12 to the client terminal 160.

### SUMMARY

The print system 1 according to the first embodiment can easily change the accumulation setting for each output.

Meanwhile, output data in the present embodiment are data of an output object, i.e. data which are an object of the output, from a stage of receiving an output request from a user at the client terminal 16 until output by the output device 17 or the like. In the output process in the present embodiment, a data format of the data of the output object is converted variously from the stage of receiving the output request from the user at the client terminal 16 until output by the output device 17 or the like.

The data of the output object are variously converted into a format of an application data (Microsoft Word (Trademark Registered) file or the like), an intermediate data format (XPS data or the like), a print data format (PDL data or the like) or the like. In the present embodiment, the data of the output object are converted at various timings.

For example, the client terminal 16 may hold the output data in the intermediate data format or in the print data format. Moreover, the print server device 14 may hold the output data in the application data format or in the intermediate data format. The output data are only necessary to be in the print data format, when the print is performed at the output device 17 or the like.

Moreover, when the print job for the intermediate data format can be performed at the output device 17 (for example, PDF data or the like), the print server device 14 or the client terminal 16 may send the output data in the intermediate data, format, to enable executing the print job. The output data in the intermediate data format may be used as output data in the print data format.

Accordingly, a data format of the output data in the present embodiment, from the stage of receiving the output request from the user at the client terminal 16 until output by the output device 17 or the like, is not necessarily identified. As the output data in the present embodiment, data selected as an object for which the user requires an output are treated.

Moreover, the output control system is more than one information processing apparatus connected with the client terminal 16 or the output device 17 via the network, and is, for example, more than one print server device 14, an authentication server device 13 and a print server device 14 or the like. The output control system is provided with a function of controlling the output process (print process), from the output request executed from the client terminal 16 by the user until the output processing executed at the output device 17 or the like by the user. Meanwhile, the output control system may include a device other than the authentication server device 13 and the print server device 14.

The present invention is not limited to the above-described embodiment, which has been disclosed specifically, but various variations and modifications may be made without departing from the scope of the invention as set forth in the accompanying claims. The print system 1 in the above described embodiment is an example of an output system. The client terminal 16 is an example of a terminal device.

Moreover, a setting management unit recited in claims corresponds to the setting management unit 74. A selection reception unit corresponds to the print flow control unit 71. An accumulation control unit corresponds to the print data accumulation unit 81. An output data related information retention unit corresponds to the print job information retention unit 114. An output unit corresponds to the function of the output devices 15, 17 of outputting real print data.

An output control unit corresponds to the print control unit 102. A first account control unit corresponds to the account control unit 103. A second account control unit corresponds to the account control unit 112. An authentication process unit corresponds to the authentication processing unit 101. A display unit corresponds to the display unit 72. A flow information retention unit corresponds to the print flow setting unit 73. A flow execution unit corresponds to the print flow control unit 71.

An output data related information transmission unit corresponds to the print job management unit 82. An output data transmission unit corresponds to the print flow control unit 71. An instruction user who sends an output request corresponds to the print-requiring user. An output setting based on bibliographic information of the output data corresponds to the print setting based on the print job information of the print data.

The present application is based on and claims the benefit of priority of Japanese Priority Application No. 2013-226358 filed on Oct. 31, 2013, the entire contents of which are hereby incorporated by reference.

### DESCRIPTION OF THE REFERENCE NUMERALS

1 print system
11 administrator terminal
12 application server device
13 authentication server device
14 print server device
15 local output device
16 client terminal
17 shared output device
21 document preparation application
22,22a virtual printer driver
23 real printer driver
24 plug-in application
25 platform API
26 platform
27 storage unit
31 plug-in
41 display control (UI control) unit
42 setting unit
43 communication unit
50 software package
51 function plug-in
52 main body
61 job accumulation plug-in
62 proxy print plug-in
63 account plug-in
64 rule-based print control plug-in
71 print flow control unit
72 display unit
73 print flow setting unit
74 setting management unit
75 setting information retention unit
81 print data accumulation unit
82 print job management unit
83 server connection unit
84 print job information retention unit
85 setting information retention unit
91 user information addition unit
92 proxy user management unit
93 server connection unit
94 proxy user information retention unit
95 setting information retention unit
101 authentication processing unit
102 print control unit
103 account control unit
104 setting information retention unit
111 print control unit
112 account control unit
113 print data retention unit
114 print job information retention unit
500 computer
501 input device
502 display device
503 external I/F
503a recording medium
504 RAM
505 ROM
506 CPU
507 communication I/F
508 HDD
1000,1000a basic setting screen
1010 server setting screen
1020 job accumulation setting screen
1030 proxy print setting screen
1040 account setting screen
2000 print setting screen
2001 printer selection column
2002 property button
2003 OK button
2010 function selection screen
2020 print job information list screen
B bus
N1 network

1. An output system, in which a terminal device, one or more output devices and an output control system including one or more information processing devices are connected via a network, comprising:
a setting management unit that receives a setting for a first function of accumulating output data at the terminal device and a setting for a second function of accumulating the output data at the output control system;
a selection reception unit that receives, at the terminal device, a selection of a function to accumulate the output data, which are required to be output, the selection indicating either the first function or the second function;
an accumulation control unit that accumulates the output data at the terminal device when the first function is selected and accumulates the output data at the output control system when the second function is selected;
an output data related information retention unit that retains output data related information related to the output data accumulated by the selected function at the output control system or at the terminal device, at the output control system; and
an output unit that receives the output data related information from the output control system, acquires the output data accumulated at the terminal device or at the output control system based on the output data related information and outputs the output data at the output device.

2. The output system as claimed in claim 1 further comprising:
an output control unit that specifies the output device to which an output request for the output data is sent and sends the output request for the output data to the specified output device when the selection reception unit receives a selection of a function of sending account information of the output data to a predetermined account storage unit at the terminal device;
a first account control unit that records the account information of the output data in the predetermined account storage unit, the output request for the output data being sent to the specified output device by the output control unit, at the terminal device; and
a second account control unit that records the account information of the output data in the predetermined account storage unit when the output device outputs the output data acquired based on the output data related information at the output control system.

3. The output system as claimed in claim 2 further comprising an authentication processing unit that sends the output request for the output data to the specified output device and executes an authentication process for a user when the selection reception unit accepts the selection of the function of sending account information of the output data to the predetermined account storage unit at the terminal device, wherein the output control unit does not send the output request for the output data to the specified output device when authentication by the authentication processing unit fails, and the first account control unit and the second account control unit record the account information associated with the user in the predetermined account storage unit.

4. The output system as claimed in any one of claims 1 to 3 further comprising a display unit that displays a selection screen for selecting any one of the first function and the second function, wherein the setting management unit receives a setting whether to display the selection screen for selecting any one of the first function and the second function upon receiving the output request for the output data and a setting of selecting a function in advance when the selection screen is not displayed, the display unit displays the selection screen when the selection screen for selecting any one of the first function and the second function upon receiving the output request for the output data is set to be displayed, and the selection reception unit receives the function selected based on the selection screen or the function selected in advance as the selected function.

5. The output system as claimed in any one of claims 1 to 4 further comprising:
a flow information retention unit that retains flow information that defines a processing flow in sending the output request for the output data from the terminal device; and
a flow execution unit that executes a processing flow based on the flow information and sends the output request for the output data at the terminal device, wherein the setting management unit receives a setting whether to execute the processing flow based on the flow information upon receiving the output request for the output data, the selection reception unit receives the output request for the output data for which the processing flow is executed based on the flow information when the processing flow based on the flow information is set to be executed, and the selection reception unit receives the output request for the output data accumulated by the selected one of the first function and the second function when the processing flow based on the flow information is set not to be executed.

6. The output system as claimed in any one of claims 1 to 5, wherein the second function of accumulating the output data at the output control system is a proxy output function, the accumulation control unit accumulates the output data at the output control system when the proxy output function is selected, and the output data related information retention unit retains the output data related information including user identification information of an instruction user who sends the output request from the terminal device and user identification information of a proxy user specified by the instruction user as the output data related information related to the output data for which the proxy output function is selected.

7. The output system as claimed in any one of claims 1 to 6, wherein the output data related information retention unit retains the output data related information including information of an accumulation destination of the output data accumulated at the terminal device as the output data related information related to the output data for which the first function of accumulating at the terminal device is selected.

8. The output system as claimed in claim 5, wherein the flow information can define a process of executing any one of the first function and the second function or a process of determining a setting for outputting based on bibliographic information of the output data.

9. A terminal device comprising:
a setting management unit that receives a setting for a first function of accumulating output data at the terminal device and a setting for a second function of accumulating the output data at an information processing device connected via a network;
a selection reception unit that receives a selection of a function to accumulate the output data, which are required to be output, the selection indicating either the first function or the second function;
an accumulation control unit that accumulates the output data at the terminal device when the first function is selected and accumulates the output data at the information processing device when the second function is selected;
an output data related information transmission unit that transmits output data related information related to the output data accumulated by the selected function at the terminal device or at the information processing device to the information processing device; and
an output data transmission unit that transmits the output data accumulated at the terminal device to an output device when an acquisition request for the output data accumulated at the terminal device is sent to the terminal device based on the output data related information received by the output device from the information processing device.

10. An output method executed in an output system, in which a terminal device, an output device and an output control system including one or more information processing devices are connected via a network, wherein the terminal device includes a first accumulation unit that accumulates output data and the output control system includes a second accumulation unit that accumulates the output data and an output data related information retention unit that retains output data related information related to the accumulated output data accumulated at the first accumulation unit or at the second accumulation unit, the method comprising:
a setting management step of receiving a setting for a first function of accumulating the output data at the first accumulation unit and a setting for a second function of accumulating the output data at the second accumulation unit;
a selection reception step of receiving, at the terminal device, a selection of a function to accumulate the output data, which are required to be output, the selection indicating either the first function or the second function;
an accumulation control step of accumulating the output data at the first accumulation unit when the first function is selected and accumulating the output data at the second accumulation unit when the second function is selected; and
an output step of acquiring the output data accumulated at the first accumulation unit or at the second accumulation unit based on the output data related information and outputting the output data at the output device.
